(19) United States
(12) Patent Application Publication
(10) Pub. No.: US 2025/0143322 A1
(43) Pub. Date: May 8, 2025

(54) BACTERIAL COMPOSITION FOR IMPROVING PLANT-RELATED PARAMETERS AND METHODS OF USING THE SAME

(71) Applicant: YISSUM RESEARCH DEVELOPMENT COMPANY OF THE HEBREW UNIVERSITY OF JERUSALEM LTD., Jerusalem (IL)

(72) Inventors: Saul BURDMAN, Jerusalem (IL); Edouard JURKEVITCH, Jerusalem (IL); Yael HELMAN, Jerusalem (IL)

(21) Appl. No.: 18/697,970

(22) PCT Filed: Jan. 30, 2023
(86) PCT No.: PCT/IL2023/050103

§ 371 Date: Apr. 2, 2024

Related U.S. Application Data
(60) Provisional application No. 63/267,340, filed on Jan. 31, 2022.

(51) Int. Cl. A01N 63/25; A01N 63/20; A01P 21/00

(52) U.S. Cl. CPC A01N 63/25; A01N 63/20; A01P 21/00

(57) ABSTRACT

The present disclosure relates to a method and composition for improving at least one plant-related parameter in cucurbitaceous the method comprising: contacting a plant or plant part with an amount of at least one bacterium, the at least one bacterium, the amount of said at least one bacterium being effective to provide an improvement in said at least one plant-related parameter. Also disclosed is a kit comprising the at least one bacterium and instructions for use of the at least one bacterium for improving at least one plant-related parameter in cucurbitaceous.

### TECHNOLOGICAL FIELD

The present disclosure relates to agriculture and in particular to improving plant performance.

### BACKGROUND ART

The reference considered to be relevant as background to the presently disclosed subject matter is listed below:
Lapidot, D. et al., Plant Pathol. 2014, 64, 545-551.

Acknowledgement of the above reference herein is not to be inferred as meaning that this is in any way relevant to the patentability of the presently disclosed subject matter.

### BACKGROUND

The interaction between soil bacteria and plants may be (from the perspective of the plant) beneficial, harmful, or neutral.

Paenibacillus dendritiformis is a pattern-forming, Gram-positive, soil bacterium. Lapidot et al. (2014) showed that P. dendritiformis has the ability to increase potato crop yield and reduce the virulent outcome of pectinolytic bacteria on potatoes in in vitro experiments, in the greenhouse and in the field. The reduction of the outcome was demonstrated on potato slices and in the greenhouse but not in the field, as there was no disease outcome even in control plants.

### GENERAL DESCRIPTION

The present disclosure provides a method for improving at least one plant-related parameter in cucurbitaceous the method comprising: contacting a plant or plant part with an amount of at least one bacterium, the at least one bacterium comprising at least Paenibacillus dendritiformis (P. dendritiformis), the amount of said at least one bacterium being effective to provide an improvement in said at least one plant-related parameter.

The present disclosure also provides a composition for use in improving at least one plant-related parameter in cucurbitaceous, the composition comprising at least one bacterium, the amount of said at least one bacterium being effective to provide an improvement in said at least one plant-related parameter, wherein the at least one bacterium comprising at least Paenibacillus dendritiformis (P. dendritiformis).

Yet further, the present disclosure provides a kit comprising at least one bacterium that is capable for improving at least one plant-related parameter in cucurbitaceous, wherein the at least one bacterium comprises at least Paenibacillus dendritiformis (P. dendritiformis); and instructions for use of the at least one bacterium, said instructions comprises contacting a plant or plant part from cucurbitaceous family, with an amount of said at least one bacterium, the amount of said at least one bacterium being effective to provide an improvement in said at least one plant-related parameter.

The present disclosure also provides a method for improving at least one plant-related parameter in cucurbitaceous the method comprising: contacting a plant or plant part with an amount of at least one bacterium, the at least one bacterium comprising at least Azospirillum brasilense (A. brasilense), the amount of said at least one bacterium being effective to provide an improvement in said at least one plant-related parameter.

The present disclosure also provides a composition for use in improving at least one plant-related parameter in cucurbitaceous, the composition comprising at least one bacterium, the amount of said at least one bacterium being effective to provide an improvement in said at least one plant-related parameter, wherein the at least one bacterium comprising at least Azospirillum brasilense (A. brasilense).

Yet further, the present disclosure provides a kit comprising at least one bacterium that is capable for improving at least one plant-related parameter in cucurbitaceous, wherein the at least one bacterium comprises at least Azospirillum brasilense (A. brasilense); and instructions for use of the at least one bacterium, said instructions comprises contacting a plant or plant part from cucurbitaceous family, with an amount of said at least one bacterium, the amount of said at least one bacterium being effective to provide an improvement in said at least one plant-related parameter.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-1E are graphs showing root colonization ability of two strains of Azospirillum brasilense (Sp7 (Ab) or Cd) and one strain of Paenibacillus dendritiformis T (Pd) on roots of tomato cv. M82 (FIG. 1A, FIG. 1D), melon cv. Ofir (FIG. 1B, FIG. 1E), and wheat cv. Bar Nir (FIG. 1C). Seven-day-old roots were incubated for 2 or 24 h in bacterial suspensions with 10⁸ CFU mL⁻¹. After gentle washing of the roots, bacteria were detached from the roots by vortex (V), followed by homogenization (H), and CFU g⁻¹ root were determined by dilution plating following each one of the treatments. Data represents means and standard errors (SE) of four replicates per treatment of one experiment, out of four with similar results.

FIGS. 2A-2E show assessment of compatibility of Azospirillum brasilense Sp7 and Paenibacillus dendritiformis T for co-inoculation experiments. P. dendritiformis T was inoculated on Luria Bertani agar (LA) plates 24 h prior inoculation of the tested bacterial strains. Plant pathogenic bacteria: Cmm, Clavibacter michiganensis susbp. michiganensis NCPPB 382; Pst, Pseudomonas syringae pv. Tomato DC3000; Ac, Acidovorax citrulli M6 (FIG. 2A). Azospirillum brasilense Sp7 (FIG. 2B). Dotted circles in FIG. 2A indicate the zones of growth inhibition. Laser-scanning confocal images of fluorescence in situ hybridization analyses using melon cv. AN-305 roots inoculated with A. brasilense Sp7 (FIG. 2C), P. dendritiformis T (FIG. 2D) and combination of A. brasilense sp7+P. dendritiformis T (FIG. 2E). Hybridization was performed on 24 day-old-plant grown in sand pots. The probe for A. brasilense was conjugated to cy5 fluorophore (ex 543), and the probe for P. dendritiformis was conjugated to cy3 fluorophore (ex 633). Image in (FIG. 2E) is an overlay of the two fluorescence fields with pink zones depicted by white arrows indicate the presence of A. brasilense and P. dendritiformis.

FIGS. 3A-3D show assessment of tolerance to saline irrigation of melon cv. Ofir (FIGS. 3A, 3C, 3D) and tomato cv. M82 (FIG. 3B) plants. Plants were grown in sandy soil and were irrigated with different NaCl concentrations (50 mM, 100 mM and 150 mM). Control plants were irrigated with non-salinized irrigation solution. Plants were irrigated manually for 45 days. Data represents means and standard errors (SE) of six replicates per treatment. Different letters indicate significant statistical differences (p<0.05) according to one way ANOVA and Tukey post hoc. Similar results were obtained with melon varieties Raymond and AN-305.

FIGS. 4A-4E show growth promotion of melon seedlings (cultivars Ofir, Raymond and AN-305) induced by inoculation of Azospirillum brasilense Sp7 (Ab), Paenibacillus dendritiformis T (Pd), and their combination (Ab+Pd) under salinity stress. Experiments were carried out in germination papers using the “cigar roll” method. Ten seeds previously soaked in the appropriate bacterial suspension were used in each roll (FIG. 4A). Growth parameters were measured after 10 days: root dry weight (FIG. 4B); root length (FIG. 4C); number of lateral roots (FIG. 4D); and number of lateral roots longer than 2 cm (FIG. 4E). Data represents means and SE of 30 replicates (plants) per treatment from one experiment out of two with similar results. Different letters indicate significant statistical differences (p<0.05) according to one way ANOVA and Tukey post hoc.

FIGS. 5A-5D show growth of tomato (cv. M82) seedlings in response to inoculation with Azospirillum brasilense Sp7 (Ab), Paenibacillus dendritiformis T (Pd), and their combination (Ab+Pd) under salinity stress. Experiments were carried out in germination papers using the “cigar roll” method. Ten seeds previously soaked in the appropriate bacterial suspension were used in each roll. Growth parameters were measured after 10 days: root dry weight (FIG. 5A); root length (FIG. 5B); number of lateral roots (FIG. 5C); and number of lateral roots longer than 2 cm (FIG. 5D). Data represents means and SE of 30 replicates per treatment from one experiment out of two with similar results. Similar letters indicate no significant statistical differences (p<0.05) according to one way ANOVA and Tukey post hoc.

FIGS. 6A-6C show growth promotion of melon plants (cultivars ofir, raymond and an-305) induced by inoculation of Azospirillum brasilense sp7 (Ab), Paenibacillus dendritiformis T (Pd), and their combination (Ab+Pd). Plants were grown in the greenhouse in 2 L pots filled with sand, under saline stress (irrigation solution with NaCl at an EC of ˜3.5 dS m⁻¹). At 57 days after sowing, root dry weight (FIG. 6A) and shoot dry weight (FIG. 6B) were measured. A representative image of AN-305 roots obtained from the different treatments (FIG. 6C). Data in graphs represent means and SE of 20 replicates per treatment from one experiment out of two with similar results. Different letters indicate significant statistical differences (p<0.05) according to one way ANOVA and Tukey post hoc.

FIGS. 7A-7B are graphs showing growth of tomato (cv. M82) plants in response to inoculation with Azospirillum brasilense Sp7 (Ab), Paenibacillus dendritiformis T (Pd), and their combination (Ab+Pd). Plants were grown in the greenhouse in 2-L pots filled with sand, under saline stress (irrigation water containing 50 mM NaCl). At 57 days after sowing, shoot dry weight (FIG. 7A) and root dry weight (FIG. 7B) were measured. Data represents means and SE of 20 replicates per treatment from one experiment out of two with similar results. Similar letters indicate no significant statistical differences (p<0.05) according to one way ANOVA and Tukey post hoc.

FIGS. 8A-8B are graphs showing the effect of Azospirillum brasilense Sp7 (Ab), Paenibacillus dendritiformis T (Pd) and their combination (Ab+Pd) on total antioxidant activity (DPPH radical scavenging activity) in melon plants (cultivar Ofir) grown for 45 days in the greenhouse under saline stress (irrigation solution with NaCl at an EC of ˜3.5 dS m⁻¹). Results represent percentage of DPPH radical scavenging activity in 1 g of fresh root (FIG. 8A) or leaf tissue (FIG. 8B). Data are means and SE of four replicates from one experiment out of two with similar results. Different letters indicate significant statistical differences (p<0.05) according to one way ANOVA and Tukey post hoc.

FIGS. 9A-9F show the effects of inoculation with Azospirillum brasilense Sp7 (Ab), Paenibacillus dendritiformis T (Pd), and their combination (Ab+Pd) on yield of melon cv. AN-305 under saline stress in the field. Seeds were sown in Hishtil-Ashkelon (20 Aug. 17) and the resulting plantlets were planted in a field at Zohar Experimental Station (Ein Tamar, Negev) at 4 Sep. 17. Inoculation treatments were applied at sowing (FIG. 9A) and just before planting in the field (FIG. 9B). The field at planting (FIG. 9C); picture taken during the growth period (8 Oct. 17) n(FIG. 9D). The plants were irrigated using standard, commercial irrigation, and fertilization regimes with local water (EC ˜3.5-4.0). The experiment was finalized about two months after planting (8 Nov. 17). Fruits were collected, counted, and weighted. Data represents means and SE of 20 randomized plots per treatment; each plot containing 10 plants. Average number of fruits per plot (FIG. 9E); Average fruit weight per plot (FIG. 9F). Different letters indicate significant statistical differences (p<0.05) according to one way ANOVA and Tukey post hoc.

FIG. 10 is a graph showing that Paenibacillus dendritiformis T was able to reduce disease severity of melon caused by Acidovorax citrulli. In a greenhouse experiment the foliage of melon (cv. Gaya 2641) plants were spray-inoculated with Azospirillum brasilense Sp7 (Ab), P. dendritiformis T (Pd) or with a combination of both strains at the same concentrations (Ab+Pd). Control plants were sprayed with water. After 4 h, the leaves were spray-inoculated with A. citrulli M6 and disease severity of inoculated leaves was determined 6 d.a.i. Data represent means and SE of 5 replicates (plants) per treatment of one experiment, out of three experiments that showed similar results. Different letters indicate significant statistical differences (p<0.05) according to one way ANOVA and Tukey post hoc. Representative images are shown for each treatment.

FIG. 11 is a graph showing that Paenibacillus dendritiformis T was able to induce systemic resistance in melon plants. In a greenhouse experiment, seedlings of melon (cv. Gaya 2641) were inoculated with Azospirillum brasilense Sp7 (Ab), P. dendritiformis T (Pd) or with combination of both strains (Ab+Pd) twice- at sowing and at seedling transfer to pots- as described for plant-growth promotion experiments. Control plants were noninoculated plants. Two weeks after seedling transferring, the foliage of all plants were inoculated with A. citrulli And disease severity of inoculated leaves was measured 6 d.a.i. with A. citrulli. Data represents means and SE of 5 replicates (plants) per treatment of one experiment, out of three experiments that showed similar results. Different letters indicate significant statistical differences (p<0.05) according to one way ANOVA and Tukey post hoc. Representative images are shown for each treatment.

FIGS. 12A-12C show images of leaves (FIG. 12A), whole plant (FIG. 12B) or graph (FIG. 12C) exhibiting a reduced disease severity of melon plants (cultivars Rachel) caused by Acidovorax citrulli in response to inoculation of Paenibacillus dendritiformis T (Pd), Bacillus mycoides (Bm) YH1 and their combination (Pd+Bm). In a greenhouse experiment the foliage of melon (cv. Rachel) plants were spray-inoculated with Bacillus mycoides (Bm), P. dendritiformis T (Pd) or with a combination of both strains at the same concentrations (Pd+Bm). Control plants were sprayed with water. After 4 h, the leaves were spray-inoculated with A. citrulli M6 and disease severity of inoculated leaves was determined 6 d.a.i. Disease severity was assessed using the following scale: 0: no symptoms; 1: few minor lesions; 2: few small necrotic spots; 3: increased necrotic spots in less than 25% of the leaf area; 4: increased necrotic spots in 25% to 50% of the leaf area; 5: increased necrotic spots in more than 50% of the leaf area or dead leaf Data represent means and SE of 9-14 replicates (plants) per treatment of one experiment, out of four experiments that showed similar results. Different letters indicate significant statistical differences (p<0.0001) according to one way ANOVA and Tukey post hoc. Representative images are shown for each treatment.

FIGS. 13A-13C show an in vitro assay to determine the interactions between A. citrulli and Paenibacillus dendritiformis T (Pd), Bacillus mycoides (Bm) YH1. Schematic illustration of an in vitro assay (FIG. 13A). A graph showing the significant reduction in the colony forming units of A. citrulli co-cultured with either Paenibacillus dendritiformis T (Pd), Bacillus mycoides (Bm), or both (PB) (p<0.0001) according to one way ANOVA and Tukey post hoc (FIG. 13B). Representative images are shown for each treatment (FIG. 13C).

FIGS. 14A-14D show an improved biomass and root quality in cucumber plants (cultivars NONAME) in response to inoculation with P. dendritiformis. Representative pictures of the treatment groups at 14 days (FIG. 14A) and 20 days (FIG. 14B) from seeding. (F) signifies fertilization treatment; (Pd) signifies inoculation with P. dendritiformis strain; (Pd+GE) signifies inoculation with P. dendritiformis and germination enhancer (GE); and control plants. Also provided is a graph showing a significant improvement in leafs biomass of the groups treated with P. dendritiformis relative to the control group (FIG. 14C); and a graph showing a significant improvement in roots quality in the groups treated with P. dendritiformis relative to the control group (FIG. 14D).

### DETAILED DESCRIPTION

The presently disclosed subject matter is based on the finding that when contacting a plant from the cucurbitaceous family (in the non-limiting example, melon) with at least one bacterium being Paenibacillus dendritiformis (P. dendritiformis), the plant exhibited tolerance to abiotic stress induced by irrigating with saline rich medium (salinity stress). The positive effect of the exposure of the plant to the at least one bacterium was comparable to the control group, where the development of the same plant, exposed to the same abiotic stress condition, was damaged.

The presently disclosed subject matter is also based on the finding that when contacting another plant from the cucurbitaceous family (in the non-limiting example, cucumber) with at least P. dendritiformis, the plant exhibited tolerance to abiotic stress induced by shortage in nutrients (e.g. minerals) that are required for the development and growth of the plant, in the absence of the at least one bacterium.

Yet further, the presently disclosed subject matter is based on the finding that when contacting a plant from the cucurbitaceous family (in the non-limiting example, melon), with at least P. dendritiformis, the plant exhibited tolerance or resistance to pathogens which would otherwise negatively affect at least one plant related parameter. In other words, the treatment with the at least one bacterium being at least P. dendritiformis promoted a plant pathogen resistance response.

Further, the presently disclosed subject matter is based on the finding that when P. dendritiformis was combined with Bacillus mycoides or with Azospirillum brasilense (A. brasilense), the positive effect of the combined was beneficial as well.

The above findings were unexpected since P. dendritiformis was unable, as shown in the following non-limiting examples, to improve plant related parameters in another plant family, tomatoes (belonging to the Solanaceae family).

Thus, in accordance with a first aspect of the presently disclosed subject matter, there is provided a method for improving at least one plant-related parameter in at least one plant belonging to the cucurbitaceous family, the method comprising contacting the plant or a part of the plant with an amount of at least one bacterium, the at least one bacterium comprising at least P. dendritiformis, and the amount of the at least one bacterium being effective to provide an improvement in the at least one plant-related parameter.

In accordance with a second aspect of the presently disclosed subject matter, there is provided a composition for use in improving at least one plant-related parameter in cucurbitaceous, the composition comprising at least one bacterium, in an amount effective to provide an improvement in said at least one plant-related parameter, wherein the at least one bacterium comprising at least Paenibacillus dendritiformis (P. dendritiformis).

Further, in accordance with a third aspect of the presently disclosed subject matter, there is provided a kit comprising (i) at least one bacterium that is capable for improving at least one plant-related parameter in cucurbitaceous, wherein the at least one bacterium comprises at least Paenibacillus dendritiformis (P. dendritiformis); and (ii) instructions for use of the at least one bacterium, said instructions comprises contacting a plant or plant part from cucurbitaceous family, with an amount of said at least one composition, the amount of said composition being effective to provide an improvement in said at least one plant-related parameter.

The present disclosure is also based on the finding that when contacting a plant from the cucurbitaceous family (in the non-limiting example, melon) with at least one bacterium being Azospirillum brasilense (A. brasilense), the plant exhibited tolerance to abiotic stress induced by irrigating with saline rich medium (salinity stress). The positive effect of the exposure of the plant to the at least one bacterium was comparable to the control group, where the development of the same plant, exposed to the same abiotic stress condition, was damaged.

Thus, the presently disclosed subject matter also provides a method for improving at least one plant-related parameter in at least one plant belonging to the cucurbitaceous family, the method comprising contacting the plant or a part of the plant with an amount of at least one bacterium, the at least one bacterium comprising at least Azospirillum brasilense (A. brasilense), and the amount of the at least one bacterium being effective to provide an improvement in the at least one plant-related parameter.

The presently disclosed subject matter also provides a composition for use in improving at least one plant-related parameter in cucurbitaceous, the composition comprising at least one bacterium, in an amount effective to provide an improvement in said at least one plant-related parameter, wherein the at least one bacterium comprising at least Azospirillum brasilense (A. brasilense).

Further, the presently disclosed subject matter also provides a kit comprising (i) at least one bacterium that is capable for improving at least one plant-related parameter in cucurbitaceous, wherein the at least one bacterium comprises at least Azospirillum brasilense (A. brasilense); and (ii) instructions for use of the at least one bacterium, said instructions comprises contacting a plant or plant part from cucurbitaceous family, with an amount of said at least one composition, the amount of said composition being effective to provide an improvement in said at least one plant-related parameter.

For simplicity, in the above and below description, when describing components, aspects and/or non-limiting examples of the herein disclosed method, it should be understood to equivalently define components, aspects and non limiting examples of the herein disclosed composition and/or kit, and vice versa, components, aspects and examples describes in relation to any one of the composition and kit should apply and define the herein disclosed method, mutatis mutandis. Further, the term “presently disclosed subject matter” is to be understood to refer, independently, to the herein disclosed methods, compositions for use and kits, even if an element or example described is not literally described in connection with a disclosed method and/or composition and/or kit.

Further, terms and definitions provided herein with reference to P. dendritiformis are to be understood to have the same meaning when referred to another bacterium, such as A. brasilense or Bacillus mycoides.

In the context of the presently disclosed subject matter when referring to “plant-related parameter” it is to be understood to encompass any parameter that characterizes the health and/or productivity of the treated plant or of a part thereof.

In some examples, the plant related parameter is at least one parameter selected from the group consisting of plant growth, germination rate, germination percentage, robustness of germination, growth rate, root biomass, root structure, root development, shoot length, shoot mass, leaf area, number of leaves per plant, leaf weight, fruit size, fruit morphology, fruit biomass, number of fruit per plant, seed count, seed size, seed morphology, plant vigor, plant total biomass, plant or plant part morphology and/or size, plant pigment, plant viability, smell, physiological state, phonological stage of plant growth, nutrient status or deprivation, chlorophyll content, photosynthetic capacity, time to crop maturity, crop yield and/or quality, colorization or veins structure, water content or status, disease condition, resistance or tolerance to pests or pathogens and any combination thereof.

In some examples, the plant related parameter is a measurable parameter and the improvement of the at least one plant related parameter in the treated plant or plant part is in comparison to an equivalent measurement in an equivalent plant or plant part that has not been treated, i.e. the same parameter measured in an untreated plant. When referring to a measurable parameter it is to be understood to encompass qualitative (e.g. using a scoring system) as well as quantitative measurement.

In some examples, the at least one plant related parameter encompasses at least plant growth. When referring to plant growth it is to be understood to encompass at least part of a plant life cycle, be it a sexual or asexual reproducing plant. In some cases, the life cycle can begin with a plant seed and continues to a mature plant.

In some examples, the at least one plant related parameter is plant growth under abiotic stress conditions, e.g. plant tolerance or resistance to abiotic stress conditions. In some examples, when referring to abiotic stress, it is to be understood to encompass any growth condition or factor that have negative impact on of a plant or plant part parameter as compared to the agriculturally acceptable growth conditions or factor for the same/equivalent plant.

In some examples, abiotic stress includes high salinity as compared to salinity in the normal growing conditions of the same/equivalent plant. For example, in the non-limiting example provided herein high salinity of growing melon included irrigation with saline water ≥3 dS/m.

Further, in some examples, abiotic stress comprises drought. Drought stress occurs when soil water content is so low that a plant's normal life processes are impaired.

In some examples, abiotic stress comprises temperature extremes (as compared to the agriculturally acceptable temperatures for growing the plant).

Abiotic stresses, especially high or hyper salinity and/or drought are primary causes of crop loss worldwide.

In some specific examples the abiotic stress conditions comprise salinity stress.

In some yet other specific example, the abiotic stress conditions comprise nutrient/mineral deficiency/shortage.

In some examples, abiotic stress comprises any one or combination of extreme wind conditions, abnormal light intensity, extreme UV radiation, high level of heavy metals, and toxicity.

In some other examples of the presently disclosed subject matter, the at least one plant related parameter is plant growth under biotic stress conditions, e.g. plant tolerance or resistance to biotic stress conditions. When referring to plant tolerance or resistance to biotic stress it is to be understood to refer to measurable tolerance or resistance to a living organism causing biotic stress.

Plant tolerance or resistance may vary from a slight measurable increase in tolerance to the effects of the living organism causing the biotic stress (e.g., its partial inhibition) to total measurable resistance such that the plant related parameter is essentially unaffected by the presence of the living organism causing the biotic stress (i.e. pathogen).

Non limiting examples of living organisms causing biotic stress include bacteria, viruses, fungi, parasites, oomycetes, protozoans, harmful insects, mites, weeds.

In some examples of the presently disclosed subject matter, the tolerance or resistance is improved in comparison to the tolerance or resistance in the untreated plant. Tolerance or resistance can be against a particular living organism causing the biotic stress, e.g. pathogen or against a wider spectrum of pathogens. Tolerance to a living organism causing biotic stress is usually defined as the plant's ability to alleviate the reduction in its fitness due to infection, without reducing the growth of the pathogen. Resistance to a living organism causing biotic stress is usually measured as the plant's ability to suppress the infection itself and reduce the resulting pathogen burden upon infection.

In the context of the present disclosure, the term “improved” or “improvement” refers to a measurable level of tolerance or resistance that is not detected in an untreated plant, as well as to an enhancement, amplification, multiplication, elevation, raise, and the like of the level of tolerance or resistance as compared to the measurable level without treatment of an equivalent/same plant.

An improved tolerance or resistance may be local, i.e. only in the plant tissue where the bacterium is contacted with, or systemically, thus reaching other parts of the plant, not necessarily at the treatment location. For example, following contact of the bacterium through the soil, the plant becomes tolerant or resistant to infection by the pathogen, in the leaves.

In some examples of the presently disclosed subject matter, the treated plant has tolerance or resistance to infection by a phytopathogenic bacterium or an enhanced tolerance or resistance to infection by a phytopathogenic bacterium.

In some examples of the presently disclosed subject matter, the living organism causing the biotic stress comprises the cucurbit pathogenic bacterium Acidovorax citrulli. (A. citrulli).

In some examples of the presently disclosed subject matter, the method comprises improving resistance or tolerance to A. citrulli in melons.

The treatment disclosed herein provides an improvement in the at least one plant related parameter. As noted hereinbefore, the improvement is determined in comparison to the level of the same measurable parameter in an equivalent plant that has not been treated by the at least one bacterium including at least P. dendritiformis.

In the context of the presently disclosed subject matter, the term “equivalent plant” means the comparison is done with a plant from the same variety or same species of the plant that has been treated.

In some examples, the improvement in the at least one plant related parameter is to be statistically significant when compared to the same parameter measured in an equivalent plant that has not been treated with the at least one bacterium as disclosed herein.

The presently disclosed subject matter is applicable to any member of the cucurbitaceous family of plants, i.e. cucurbits. In the context of the presently disclosed subject matter, the term cucurbitaceous or cucurbits encompasses any one of the following species: Curcurbita (e.g. squash, pumpkin, zucchini), Lagenaria (e.g. calabash), Citrullus (e.g. watermelon, such as C. Lanatus, C. colocynthis), Cucumis (e.g. cucumber, melon), Momordica (e.g. bitter melon), Luffa, Cyclanthera (e.g. Caigua).

In some examples of the presently disclosed subject matter, the method is for improving plant related parameter in a plant selected from the group consisting of melon (Cucumis melo), cucumber (Cucumis sativus), and pumpkin (Cucurbita pepo).

In some examples of the presently disclosed subject matter, the method for improving at least one plant related parameter in melon (Cucumis melo). In this context, when referring to melon it is to be understood to encompass any melon variety and should not be limited to a specific variety or to the varieties presented in the herein-disclosed non-limiting examples. In some examples, the melon includes, without being limited thereto, any one of Cantaloupe, Honeydew, Casaba, Ananas and Galia.

In some examples of the presently disclosed subject matter, the method for improving at least one plant related parameter in cucumber (Cucumis sativus). In this context, when referring to cucumber it is to be understood to encompass any cucumber variety and should not be limited to a specific variety or to the variety presented in the herein-disclosed non-limiting examples. In some examples, the cucumber includes, without being limited thereto, Beit Alpha (“NONAME”) variety.

In some examples of the presently disclosed subject matter, the method for improving at least one plant related parameter in pumpkin (Cucurbita pepo). In this context, when referring to pumpkin it is to be understood to encompass any pumpkin variety and should not be limited to a specific variety or to the variety presented in the herein-disclosed non-limiting examples. In some examples, the pumpkin includes, without being limited thereto, the Gad variety.

The presently disclosed subject matter comprises treatment with at least P. dendritiformis. In the context of the present disclosure, when referring to P. dendritiformis it is to be understood to encompass any agriculturally acceptable strain of P. dendritiformis. When referring to agriculturally acceptable stain of P. dendritiformis, it is to be understood to encompass strains that are at least non pathogenic to the plant to be treated therewith, i.e. non-pathogenic strains.

In some examples of the presently disclosed subject matter, the P. dendritiformis is from strain T. The term “strain T” is to be understood to encompass tip-splitting morphotype bacterium. In some examples of the presently disclosed subject matter, the strain T is strain T168 as described by Marianna Tcherpakov et al. in International Journal of Systematic Bacteriology (1999), 49, 239-246, or as identified by accession no. BGSC30A1.

In some examples of the presently disclosed subject matter, the P. dendritiformis is from strain C454 as described by Alexandra Sirota-Madi, et al. “Genome Sequence of the Pattern-Forming Social Bacterium Paenibacillus dendritiformis C454 Chiral Morphotype” Journal of Bacteriology Vol. 194, No. 8, (2012). As appreciated by those in the art strain C is one that is isolated from a medium that induces a morphotype change from t-tip to chiral morphology.

In some examples, P. dendritiformis strain T includes variants of strain T, mutants of strain T, progeny of strain T, as long as the strain used is non-pathogenic and is effective to improve at least one plant related parameter in the plant treated therewith.

In some examples of the presently disclosed subject matter, P. dendritiformis is combined with at least one additional bacterium. In other words, the method comprises contacting the plant or plant part with P. dendritiformis and with at least one additional bacterium, that is not P. dendritiformis. The act of contacting can be simultaneously or separately, as further discussed hereinbelow.

In some examples of the presently disclosed subject matter, the at least one additional bacterium is at least non-pathogenic to the plant to be treated therewith.

When referring to a non-pathogenic additional bacterium it is to be understood to be a bacterium that is incapable of causing any undesired effect on the health and/or growth and/or productivity and/or physiology and/or metabolism and/or any other undesired effect on a plant related parameter of the plant being treated therewith. Non-pathogenic includes also incapability of causing a disease in the plant being treated therewith according to the presently disclosed subject matter.

In some examples of the presently disclosed subject matter, the at least one additional bacterium is one that is non-toxic to P. dendritiformis, i.e. the contacting of P. dendritiformis with the at least one additional bacterium does not have a detectable adverse effect on the viability of P. dendritiformis.

In some examples of the presently disclosed subject matter, P. dendritiformis is non-toxic to the at least one additional bacterium, i.e. the contacting of P. dendritiformis with the at least one additional bacterium does not have a detectable adverse effect on the viability of the at least one additional bacterium.

In some examples of the presently disclosed subject matter, the at least one additional bacterium is one known to have or was identified to have lactonase activity.

In some examples of the presently disclosed subject matter, the at least one additional bacterium is one capable of suppressing virulent outcome of Gram negative bacterium, such as A. citrulli.

In some examples of the presently disclosed subject matter, the at least one additional bacterium to P. dendritiformis comprises or is Azospirillum brasilense (A. brasilense).

In some examples of the presently disclosed subject matter, the at least one additional bacterium is A. brasilense of the strain Sp7 identified by the American Type Culture Collection with the accession no. ATCC 29145.

In some examples of the presently disclosed subject matter, the at least one additional bacterium is A. brasilense of the strain Cd identified as ATCC 29710.

It is to be noted that in some aspects of the presently disclosed subject matter, the at least one bacterium in the method, composition for use and kit is A. brasilense, and in some examples, A. brasilense is of the strain Sp7 identified by the American Type Culture Collection with the accession no. ATCC 29145, and in some other examples, A. brasilense of the strain Cd identified as ATCC 29710.

In some examples of the presently disclosed subject matter, the at least one additional bacterium to P. dendritiformis comprises or is Bacillus mycoides.

In some examples of the presently disclosed subject matter, the at least one bacterium has lactonase activity and in some examples, the bacterium having lactonase activity comprises or is Bacillus mycoides.

In some examples of the presently disclosed subject matter, the at least one additional bacterium comprises or is a strain of Bacillus mycoides isolated as described in Lapidot et. al. 2014 ibid.

In some examples of the presently disclosed subject matter, the at least one bacterium with which the plant is treated comprises a combination of two or more bacteria, at least one bacterium being the P. dendritiformis.

When referring to a combination of two or more bacteria it is to be understood that the effect on the at least one plant related parameter is determined by the effect of the combined treatment.

In some examples of the presently disclosed subject matter, the combined treatment provides at least the same or similar effect as obtained by each of the two or more bacteria when applied to the plant alone. Without being limited thereto, it may be beneficial to combine two or more bacteria that, while perhaps do not act synergistically, they act via different mechanisms and thus can compensate one over the other to provide an overall improvement of the plant related parameter, under circumstances where each of the two or more bacteria would not have provided an improvement, when given alone.

In some examples of the presently disclosed subject matter, the combined treatment provides an additive effect, i.e. a total effect that is the sum of the effects of each of the two or more bacteria when given alone.

In some examples of the presently disclosed subject matter, the combined treatment provides a synergistic effect, i.e. a total effect that is greater than the sum of effects of each of the two or more bacteria when given alone.

As noted above, and in accordance with some examples of the presently disclosed subject matter, the method comprises contacting the plant or plant part with the two or more bacteria simultaneously. A simultaneous application of the two or more bacteria can be achieved by formulating the two or more bacteria in a same delivery system (e.g. within a same carrier), or by applying the two or more bacteria in different delivery system, yet, at the same time.

In some examples of the presently disclosed subject matter, the method comprises separate applications of the two or more bacteria, namely, the contacting of the plant or plant part with each of the two or more bacteria, is at two or more treatment events.

When referring to treatment events it is to be understood to encompass any one or combination of different treatment schedules, different delivery systems (formulations) and the like.

The treatment is applied to the plant or to a part of the plant.

In the context of the presently disclosed subject matter, when referring to a plant it is to be understood to refer to essentially the whole plant, as opposed to a plant part. The whole plant can be a plant seedling, as well as mature whole plant.

In the context of the presently disclosed subject matter, when referring to a plant part it is to be understood to encompass any part of a plant, as opposed to a whole plant. A plant part can include, without being limited thereto, any one or combination of plant root, plant leaves, plant seeds, plant stem, plant harvestable material, plant shoots, flowers, stalks, fruit bodies, harvested material, e.g. fruits or vegetables, tubers, rhizomes, plant seedlings and combination of same.

In some examples, the plant part can include vegetative or generative propagation material (e.g., cuttings, tubers, rhizomes, off-shoots and seeds, etc.).

In some examples, the method comprises contacting at least the plant roots with the at least one bacterium.

In some examples, the method comprises contacting at least the plant leaves with the at least one bacterium.

In some examples, the method comprises contacting at least plant seeds with the at least one bacterium.

In some examples, the method comprises contacting at least plant stem with the at least one bacterium.

In some examples, the method comprises contacting at least plant harvestable material with the at least one bacterium.

In some examples, the method comprises contacting at least plant shoots with the at least one bacterium.

In some examples, the method comprises contacting at least plant seedlings with the at least one bacterium.

The contacting of the plant or plant part can be by any means known in the art.

In the context of the present disclosure, when referring to “contacting” it is to be understood to encompass any means of supplying or exposing the plant to the at least one bacterium.

The contacting does not have to be direct contact between the at least one bacterium and the plant or plant part, and in some cases, the contacting can be by supplying the at least one bacterium to the plant surroundings (e.g. soil or growing medium), thereby providing indirect exposure of the plant or plant part to the at least one bacterium.

Non-limiting examples of contacting the at least one bacterium with the plant or plant part includes spraying, irrigating, spreading/brushing, soaking, dusting, mixing into a medium in which the plant is grown, etc.

In some examples, the contacting comprises spraying at least part of the plant (e.g. at least the leaves) with the at least one bacterium.

In some other examples, the contacting comprises via the soil surrounding or in vicinity to the plant, e.g. by irrigation.

In yet some other examples, the contacting comprises soaking or otherwise coating plant seeds with the at least one bacterium.

The at least one bacterium can be formulated with an agriculturally acceptable carrier to form a bacterial composition suitable for improving at least one plant related parameter. In some examples, the carrier is suitable for application to a plant, plant part and/or to the soil or growing medium in proximity of a plant.

Thus, as further discussed below, the presently disclosed subject matter also encompasses a composition comprising an agriculturally acceptable carrier and at least one bacterium, the composition being suitable for improving at least one plant related parameter. The presently disclosed composition is further discussed below.

The selection of an agriculturally acceptable carrier can depend on a variety of factors including the compatibility of the carrier with the delivery of the bacteria to be delivered, e.g. the at least P. dendritiformis, the mode of delivery of the bacterial composition, the at least one additional bacterium, etc. Those versed in the art of biocontrol would know how to select appropriate carriers for the delivery of the at least one bacterium as disclosed herein.

When using a combination of two or more bacteria, and in a preferred example, at least one being the P. dendritiformis, the bacteria can be in the same or different agricultural carrier, i.e. in same or different bacterial compositions. In fact, when having two different bacterial composition, they need not to be in a same or similar carrier, nor do they need to be delivered in the same manner. In other words, the plant or plant part is contacted with the two or more bacteria in different manners, e.g. at least P. dendritiformis being contacted with the plant or plant part by spraying and the at least one additional bacterium being contact with the plant or plant part by irrigation.

When using a combination of two or more bacteria, the ratio between the different bacteria can vary, depending on the plant parameter to be improved, the mode of contacting, the type of the at least one additional bacterium etc.

In some examples, the ratio between P. dendritiformis and the at least one additional bacterium is between about 1:10 and about 10:1.

In some examples, the ratio between P. dendritiformis and the at least one additional bacterium is any ratio or range within the range of between about 1:10 and about 10:1. In some examples, the ratio is about 1:10, or about 1:9; or about 1:8; or about 1:7; or about 1:6; or about 1:5; or about 1:4; or about 1:3; or about 1:2, or about 1:1 or about 2:1, or about 3:1, or about 4:1, or about 5:1, or about 6:1 or about 7:1 or about 8:1 or about 9:1 or about 10:1. In this context, the amounts of the bacteria can deviate from the recited ratio by 20%, at times, by 10% or by 5%.

In some examples, the ratio between P. dendritiformis and any other additional bacterium is about 1:1.

The at least one bacterium is applied or formulated in an amount that is effective to improve at least one plant related parameter. In some preferred examples, the at least one bacterium is P. dendritiformis or a combination of P. dendritiformis with at least one additional bacterium.

When referring to an amount effective to improve at least one plant related parameter, it is to be understood to refer to either the amount in the bacterial composition or the amount that eventually reaches the plant or plant part. The amount can be determined based on its eventual effect on the plant related parameter and the amount should be sufficient to provide a detectable and measurable (qualitative and/or quantitative) improvement of the plant related parameter.

The amount can depend upon numerous factors, e.g., the bacterium strain, the growth phase of the bacterium, the manner of contacting between the plant or plant part and the bacterium, the agriculturally chosen carrier, the plant to be treated, the plant part to be contacted with the at least one bacterium, the plant's growth stage, etc., and can readily be determined by one skilled in the art.

In some examples of the presently disclosed subject matter, the amount of the at least one bacterium can be defined by colony forming units (CFU) per defined volume of the at least one bacterium to be applied onto the plant, or per a defined plant surface area, or plant or plant part weight, and can be determined by one skilled in the art.

In some examples of the presently disclosed subject matter, when determining the amount of the at least one bacterium per a defined plant surface area it should be understood to encompass the amount of the at least one bacterium to be applied onto the at least one bacterium (i.e. the amount of the at least one bacterium, e.g. in a composition with an agriculturally acceptable carrier, prior to application).

In some examples of the presently disclosed subject matter, when determining the amount of the at least one bacterium per a defined plant surface area it should be understood to encompass the amount of the at least one bacterium determined at a time point after contacting of the at least bacterium with the plant or plant part (e.g. after a several hours, after several days, after one or several weeks, and after one or several months etc). The amount can be determined by analyzing a sample of the plant or plant part, according to methods known to those versed in the art.

In some examples of the presently disclosed subject matter, the amount of the at least one bacterium is at least about 10² CFU/ml, at least about 10³ CFU/ml, at least about 10⁴ CFU/ml, at least about 10⁵ CFU/ml, at least about 10⁶ CFU/ml, at least about 10⁷ CFU/ml, at least about 10⁸ CFU/ml, at least about 10⁹ CFU/ml.

In some examples of the presently disclosed subject matter, the amount of the at least one bacterium at the time of application onto the plant or plant part is at least about 10⁴ CFU/ml, at least about 10⁵ CFU/ml, at least about 10⁶ CFU/ml, at least about 10⁷ CFU/ml, at least about 10⁸ CFU/ml, at least about 10⁹ CFU/ml.

In some examples of the presently disclosed subject matter, the amount should be sufficient to achieve the desired improvement of at least one plant related parameter, yet without providing any adverse and undesired effect on other plant related parameters.

In some examples of the presently disclosed subject matter, the at least one bacterium is provided as an isolated and biologically pure bacterium, i.e., in a form that substantially does not contain microorganisms other than the intended at least one bacterium. In other words, each of the bacterium to be brought into contact with the plant or plant part in the context of the presently disclosed subject matter is at least 90% pure, or at least 95% pure or even 100% pure.

In some examples of the presently disclosed subject matter, the at least one bacterium is contacted with the plant or plant part when in its growth phase. When referring to the growth phase of a bacterium, it to be understood to encompass any one of a bacterium's lag phase, log phase (or exponential phase) or stationary phase.

In some examples of the presently disclosed subject matter, the at least one bacterium is in its log phase.

In some examples of the presently disclosed subject matter, the at least one bacterium is in its stationary phase.

In some examples of the presently disclosed subject matter, the at least one bacterium comprises bacterial spores. Methods for producing spores are well known in the art.

In some examples of the presently disclosed subject matter, microorganism-free media in which the bacterium have grown (e.g., bacteria cultured in the media) can be used in the compositions and methods disclosed herein.

As already described hereinabove, there is provided a composition for use in improving at least one plant-related parameter in cucurbitaceous, the composition comprising at least one bacterium, in an amount effective to provide an improvement in said at least one plant-related parameter, wherein preferably the at least one bacterium comprising at least P. dendritiformis (P. dendritiformis). The composition comprises the at least one bacterium and a carrier, preferably an agriculturally acceptable carrier.

In the context of the presently disclosed subject matter, when referring to a carrier for the at least one bacterium, it is to be understood to encompass, any agriculturally acceptable carrier that is suitable for bringing the at least one bacterium into contact (directly or indirectly) with the plant or plant part.

The composition for use, according to the presently disclosed subject matter, can be formulated as a liquid, semi liquid/semi solid or solid formulation, depending on the desired mode of delivery of the at least one bacterium.

In some examples, the carrier is one that is capable of protecting the viability and/or vitality of the at least one bacterium by providing it with, e.g. nutrition, energy, and suitable conditions for survival while brought into contact with the plant or plant part.

The at least one bacterium, either as an essentially pure bacterium or as part of a composition can be provided with instructions for use of same. The combination of the at least one bacterium in instructions for use, constitute a kit, according to the presently disclosed subject matter.

By referring to a “kit” it is to be understood to encompass an assembly of two or more components, generally for a defined purpose. The two or more components that are part of a kit may be said to be assembled or “packaged” into or as a kit or a package.

One of the components in the kit comprises the at least one bacterium. The other component in the kit comprises the instructions for use of the at least one bacterium.

The instruction can vary depending on the plant to be treated, the parameter to be improved, the identity of the at least one bacterium, the treatment schedule as well as other factors. The instructions comprise at least the method step of contacting the plant or plant part with an amount of the at least one bacterium, as defined hereinbefore.

In some examples, the instructions in the kit of the present disclosure, comprise formulating the at least one bacterium with an agriculturally acceptable carrier to obtain at least one bacterial composition suitable for improving at least one plant related parameter, along with instructions on how to bring the at least one bacterial composition into contacting with the plant or part of the plant of which improvement of at least one plant parameter is desired.

All definitions, as defined and used herein, should be understood to control over dictionary definitions, definitions in documents incorporated by reference, and/or ordinary meanings of the defined terms.

The term “about” as used herein indicates values that may deviate up to 1%, more specifically 5%, more specifically 10%, more specifically 15%, and in some cases up to 20% higher or lower than the value referred to, the deviation range including integer values, and, if applicable, non-integer values as well, constituting a continuous range. In some embodiments, the term “about” refers to ±10%.

The indefinite articles “a” and “an,” as used herein in the specification and in the claims, unless clearly indicated to the contrary, should be understood to mean “at least one” It must be noted that, as used in this specification and the appended claims, the singular forms “a”, “an” and “the” include plural referents unless the content clearly dictates otherwise.

The phrase “and or” as used herein in the specification and in the claims, should be understood to mean “either or both” of the elements so conjoined, i.e., elements that are conjunctively present in some cases and disjunctively present in other cases. Multiple elements listed with “and or” should be construed in the same fashion, i.e., “one or more” of the elements so conjoined. Other elements may optionally be present other than the elements specifically identified by the “and or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” or, when used in the claims, “consisting of” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

Throughout this specification and the Examples and claims which follow, all transitional phrases such as “comprising,” “including” “carrying” “having” “containing” “involving” “holding” “composed of” and the like are to be understood to be open-ended, i.e., to mean including but not limited to. Specifically, it should understood to imply the inclusion of a stated integer or step or group of integers or steps but not the exclusion of any other integer or step or group of integers or steps. Only the transitional phrases “consisting of” and “consisting essentially of” shall be closed or semi-closed transitional phrases, respectively, as set forth in the United States Patent Office Manual of Patent Examining Procedures. More specifically, the terms “comprises”, “comprising”, “includes”, “including”, “having” and their conjugates mean “including but not limited to”. The term “consisting of” means “including and limited to”. The term “consisting essentially of” means that the composition, method or kit may include additional components, steps and/or parts, but only if the additional components, steps and/or parts do not materially alter the basic and novel characteristics of the claimed composition, method or structure.

It should be noted that various examples of the presently disclosed subject matter may be presented in a range format. It should be understood that the description in range format is merely for convenience and brevity and should not be construed as an inflexible limitation on the scope of the invention. Accordingly, the description of a range should be considered to have specifically disclosed all the possible sub ranges as well as individual numerical values within that range. For example, description of a range such as from 1 to 10 should be considered to have specifically disclosed sub ranges such as from 1 to 3, from 1 to 4, from 1 to 5, from 2 to 4, from 2 to 6, from 3 to 10 etc., as well as individual numbers within that range, for example, 1, 2, 3, 4, 5, . . . and 10. This applies regardless of the breadth of the range. Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

It is appreciated that certain features of the presently disclosed subject matter, which are, for clarity, described in the context of separate aspects, may also be provided in combination in a single example or aspect. Conversely, various features of the presently disclosed subject matter, which are, for brevity, described in the context of a single aspect (e.g. method), may also be provided separately or in any suitable sub combination or as suitable in any other described aspects of the presently disclosed subject matter.

Disclosed and described, it is to be understood that this invention is not limited to the particular examples, methods steps, and compositions disclosed herein as such methods steps and compositions may vary somewhat. It is also to be understood that the terminology used herein is used for the purpose of describing particular embodiments only and not intended to be limiting since the scope of the present invention will be limited only by the appended claims and equivalents thereof.

The following examples are representative of techniques employed by the inventors in carrying out aspects of the presently disclosed subject matter. It should be appreciated that while these techniques examples for the practice of the presently disclosed subject matter, those of skill in the art, in light of the present disclosure, will recognize that numerous modifications can be made without departing from the spirit and intended scope of the invention.

### DETAILED DESCRIPTION OF NON-LIMITING EXAMPLES

Without further elaboration, it is believed that one skilled in the art can, using the preceding description, utilize the present invention to its fullest extent. The following preferred specific embodiments are, therefore, to be construed as merely illustrative, and not limitative of the claimed invention in any way.

### Example 1

### Experimental Material

### Bacterial Strains, Growth Conditions and Plant Material

Azospirillum brasilense strain Sp7 (Tarrand J J. Et al., Can. J. Microbiol. 1978, 24:967 980) and Paenibacillus dendritiformis strain T (Tcherpakov M, et al., 1999, Int. J. Syst. Bacteriol. 49: 239-246) were used in most experiments. In some experiments, A. brasilense strain Cd (Eskew D L, et al., Appl. Environ. Microbiol. 1977, 34:582-385) and Bacillus mycoides (BM) (Lapidot et al paper 2014, ibid.) were used. Escherichia coli SM10 (Simon R, et al., 1983, Bio-Technol 1: 784-791) was used as negative control in root colonization experiments (see below). This strain was grown and prepared for inoculation as described above for A. brasilense and P. dendritiformis, except that the growth temperature was 37° C. Bacteria were grown in Lysogenic broth (LB) (Difco Laboratories, Detroit, MI, USA) or LB 1.5% agar (LA) plates for 24 h at 28° C. For plant inoculation the cells were harvested from the agar plate and resuspended with phosphate buffer-saline solution (PBS; 10 mM sodium phosphate, 2.7 mM potassium chloride, 1.8 mM potassium phosphate, 137 mM sodium chloride; pH 7.4) to a final concentration of 10⁸ colony forming units (CFU) mL⁻¹ as adjusted by optical density at 600 nm (OD₆₀₀) of 0.2 and verified by serial dilution plating. Bacterial suspensions containing A. brasilense and P. dendritiformis or Bacillus mycoides and P. dendritiformis were prepared by mixing equal volumes of suspensions of both strains.

Plant species and varieties used in this study are described in Table 1.

TABLE 1
Plant species and varieties used in the non-limiting examples

| Plant | Variety | Source |
|---|---|---|
| Cucumis melo (melon)¹ | Ofir¹ | Zeraim Gedera |
| | Raymond¹ | Hazera Genetics |
| | AN-305¹ | Origene Seeds |
| | Gaya 2641² | Origene Seeds |
| | Glory² | Origene Seeds |
| Solanum lycopersicum (tomato) | M82 | Hazera Genetics |
| Cucumis sativus (cucumber) | Beit Alpha | Hazera Genetics |
| Cucumis sativus (cucumber) | NONAME | Beit Alpha |
| Cucurbita pepo (pumpkin) | Gad | Hazera Genetics |
| Triticum aestivum (wheat) | Bar Nir | Negev Seeds, |
| | | Kibbutz Shoval, |
| | | Israel |

¹Ananas-type melon varieties.
²Galia-type melon varieties.

### Assessment of Bacterial Root Colonization

Prior to bacterial inoculation, seeds were surface-sterilized by soaking in 70% ethanol for 1 min, followed by soaking in 1% sodium hypochlorite for 1 min. The seeds were then rinsed five times with sterile distilled water and dried on filter paper. To assess the colonization ability of the bacterial strains on melon, tomato, cucumber, pumpkin and wheat roots, seeds were germinated on germination papers using the “cigar roll” method [Bai, C. H., et al. J. Exp. Bot. 2013, 64, 1745-1753.]. Briefly, ten uniform-size seeds were placed on a moist germination paper (25 cm×38 cm; Hoffman Manufacturing, Inc., Corvallis, OR, USA). The paper was covered with another sheet of moist germination paper rolled to a final diameter of 3 cm. The bases of the rolls were placed in 1 L chemical beakers containing a water solution and they were kept in a darkened growth chamber at a constant temperature of 25° C. for seven days. Then, roots from the emerging seedlings were incubated in 10⁸ CFU mL⁻¹ suspensions of each bacterial strain at 25° C. for 2 or 24 h. After incubation, the roots were gently washed twice with sterilized PBS, dried on filter paper and weighed. The roots were then vortexed for 30 s in 1 mL of fresh PBS in 1.5-mL tubes followed by transfer to 1 mL fresh PBS and homogenized using an RZR 2-64 homogenizer (Heidolph, Schwabach, Germany). Both suspensions resulting from vortexed and homogenized roots were serially diluted and plated on LA plates for bacterial quantification. Plates were incubated at 28° C. for 48 h, after which colonies were counted to measure colonization (CFU g⁻¹ root).

### Seedling Growth in Germination Paper

Seeds of melon, tomato and cucumber were surface-sterilized as described above and incubated for 30 min in suspensions containing 10⁸ CFU mL⁻¹ of A. brasilense Sp7 and P. dendritiformis T, separately or in combination of both strains. Seedlings were grown on germination papers using the “cigar roll” method as described above. The chemical beakers contained either water or 50 mM NaCl solution. Seedlings were grown in a dark growth chamber at 25° C. After 10 days, plants were collected and the following parameters were measured: root length, root weight, number of lateral roots and number of lateral roots equal or larger than 2 cm.

### Greenhouse Experiments

All greenhouse experiments were carried out on campus in the I-Core greenhouse equipped with a desert cooler (minimum-maximum temperature: 14-36° C.). Preliminary experiments were carried out with melon and tomato plants to assess their susceptibility to saline stress. Experiments involving bacterial inoculation were performed with melon and tomato varieties described above. Seeds were surface-sterilized as described above and germinated in a vermiculite-filled tray that was irrigated with water. Then, 12-day-old seedlings were transferred to 2 L plastic pots filled with sand. The plants were irrigated with a standard nutrient solution (NPK fertilization solution; 1.8 g L⁻¹ N:P₂O₅:K₂O (5:3:8); Haifa Chemicals Ltd., Haifa, Israel), carrying NaCl at an EC of ˜3.5 dS m⁻¹, through an automatic drip irrigation system, three times per day. Bacterial inoculation was performed twice, the first time at sowing, and the second time when seedlings were transplanted to the pots. In both cases, each seed/plant was inoculated with 5 mL of bacterial suspensions of either 10⁸ CFU mL⁻¹ of A. brasilense Sp7, P. dendritiformis T or a mixed suspension containing both bacterial strains at the same concentration as in individual inoculation. Controls were non-inoculated plants. The plants were grown for 45 additional days, after which root and shoot weights were determined. All greenhouse experiments were organized in a completely randomized design with 20 replicates (plants) per treatment.

### Measurements of Total Antioxidant Enzyme Activity

Antioxidant activity was measured using the 2,2-diphenyl-1-picrylhydrazyl (DPPH) radical scavenging assay described by Zhou et al. (2018) [Zhou, Y. et al., Int. J. Mol. Sci. 2018, 19, 252.]. Forty-five-day-old melon plants (cv. Ofir) grown in the greenhouse as described above were used for this analysis. Briefly, fresh root or leaf tissue (1 g) was homogenized in an 80% methanol (v/v) solution using tissue lyser II (Qiagen, Hilden, Germany). Samples were then centrifuged at 13,000×g for 20 min at 4° C. The supernatant (2 mL) was mixed with 1 mL of 0.3 mM DPPH solution and incubated in the dark at 25° C. for 30 min. Absorbance of the solution was then measured at 517 nm. The test was carried out with four replicates per treatment. Percentage of radical scavenging activity was calculated according to the following formula:

$$DPPH radical scavenging activity \% = 100 - 100 \times [ ( {Ab}_{sample} - {Ab}_{blank} ) / {Ab}_{control} ]$$

DPPH solution in 80% methanol (v/v) served as control. The methanol solution with the corresponding plant extracts was used as blank.

### Field Experiment

A field experiment with melon cv. AN-305 was performed at the Zohar Central and Northern Arava-Tamar Agricultural Station (Ein Tamar, Israel) in a sandy soil (76-84% sand, 7-14% silt, 11-12% clay), using plantlets produced by Hishtil Nurseries (Nehalim, Israel). The experiment included four treatments: inoculation with A. brasilense Sp7 or P. dendritiformis T, inoculation with both strains, and non-inoculated controls. Bacterial treatments were applied as described for greenhouse experiments, with a first dose given at sowing in the nursery, and a second dose being applied just before transplanting the plantlets into the field (14 days after sowing). The plants were planted in four rows (200 plants per row), at intervals of 0.4 m. The experiment was set up as a randomized design, including twenty replicates (plots) per treatment, each plot containing 10 plants. Plants were covered with an insect screen until 25 days after planting to avoid virus damage. The plants were irrigated with local, saline irrigation (EC˜3.5 ds m⁻¹), with an application of standard fertilization optimized for commercial cultivation of the crop. The experiment was finalized 120 days after transplanting. The fruits of all the plots were collected, counted and weighed.

### Fluorescence in Situ Hybridization Experiments

Fluorescence in situ hybridization (FISH) analyses were carried out on 24-day-old melon plants (cv. AN-305) grown in sand pots and inoculated with A. brasilense Sp7, P. dendritiformis T or with both strains as described for greenhouse experiments. Probe design for A. brasilense and P. dendritiformis was performed with the PROBE Design tool of the ARB software package [Kumar, Y. et al., BMC Bioinform. 2005, 6, 61]. Oligonucleotide probes were modified at the 5′-end with the fluorescent fluorophores Cy3 for the P. dendritiformis probe (5′-GGATAGGCGATTTCCTCGCA-3′; 16S rRNA position 1149-1169) and Cy5 for the A. brasilense probe (5′-CCACCTTCGGGTAAAGCCA-3′; 16S rRNA position 1176-1196). Prior to hybridization, root samples (5 cm in length) were fixed in 35% formaldehyde for 24 h at 4° C. followed by dehydration in increasing concentrations of ethanol (10 min in each of the following concentrations: 50%, 70%, 85%, and 100%). Hybridization was performed at 42° C. for 4 h using hybridization buffer containing 0.9 M NaCl, 20 mM Tris HCl (pH 7.2), 5 mM EDTA, 0.001% SDS and 35% formamide. The specific probes were added to a final concentration of 30% (v/v) for each probe. Following incubation, the hybridization solution was drained and replaced with pre-warmed 80 mM washing buffer containing 10 M NaCl, 20 mM Tris HCl (pH 7.2), 10 mM EDTA. Samples were visualized using a Zeiss LSM-510 confocal laser-scanning microscope (Carl Zeiss, Jena, Germany) with two-helium neon lasers for excitation of Cy3 and Cy5 at 543 and 633 nm, respectively. Samples were observed under water immersion using a 63× objective.

### Biocontrol Experiments

Experiments were carried out to assess the ability of A. brasilense Sp7 and P. dendritiformis T to suppress disease of melon caused by the cucurbit pathogenic bacterium Acidovorax citrulli. A. citrulli infects all aerial parts of cucurbit plants causing bacterial fruit blotch (BFB) disease. BFB is considered a serious threat to the cucurbit industry, and mainly of melon and watermelon (Burdman and Walcott 2012). Two types of experiments were carried out in a greenhouse at 27-28° C. In all experiments, the Galia-type cultivar Gaya 2641 was used. In the first type of experiments, both A. brasilense Sp7, P. dendritiformis T and A. citrulli strain M6 were spray-inoculated on melon leaves to assess the ability of A. brasilense Sp7 and P. dendritiformis T to provide local protection against A. citrulli M6. In these experiments, melon seeds were sown in trays filled with vermiculite and irrigated with water. After 12 days, the seedlings were transferred to plastic pots (one plant per pot) filled with sand. Two weeks later, the foliage of the plants were spray-inoculated with 10⁸ CFU/ml of Azospirillum brasilense Sp7, P. dendritiformis T, or with a combination of both strains at the same concentrations. Control plants were sprayed with water. After 4 h, the leaves were spray-inoculated with A. citrulli M6 at ˜10⁵ CFU/ml. The plants were then covered with a plastic bag for 24 h to promote infection by A. citrulli. In the second type of experiments, A. brasilense Sp7 and/or P. dendritiformis T were inoculated via the soil/roots to assess the ability of these bacteria to induce systemic resistance in the leaves. Melon plants were grown as described above for the first type of experiments. Inoculation with A. brasilense Sp7, P. dendritiformis T, or with a combination of both strains was carried out twice- at sowing and at seedling transfer to pots- in a similar way as described for plant-growth promotion experiments. Control plants were non-inoculated plants. Two weeks after seedling transferring, the foliage of the plants were inoculated with A. citrulli M6 at ˜10⁵ CFU/ml and the plants were covered with plastic bags for 24 h to promote infection by A. citrulli. In both types of experiments, disease severity was assessed 6 days after inoculation with A. citrulli, using the following scale: 0, no symptoms; 1, few little lesions; 2, increased necrotic spots; 3, large necrotic regions covering up to 50% of the leaf; and 4, large necrotic regions covering over 50% of the leaf or dead leaf. Three experiments of each type were carried out with 5 replicates (plants) per treatment, per experiment.

### Statistical Analyses

Data were analyzed by one-way analysis of variance (ANOVA) and the Tukey post hoc test using the JIMP software (SAS Institute Inc., Cary, NC, USA).

Azospirillum brasilense Sp7 and Paenibacillus dendritiformis T Efficiently Colonize Melon and Tomato Roots

An important trait of efficient plant-growth-promoting rhizobacteria (PGPRs) is their ability to colonize the plant's roots. The root colonization ability of A. brasilense Sp7 and P. dendritiformis T in melon and tomato plants was examined. Colonization efficiency was compared to that of Escherichia coli, which is not a natural root colonizer and thus could serve as a non-efficient colonization control. Wheat roots were used as a positive control for bacterial colonization since A. brasilense strains are known to effectively colonize the roots of this and other cereals [Michiels, K. W.; J. Gen. Microbiol. 1991, 137, 2241-2246]. Bacterial numbers (normalized to CFU per gram root) were determined following mechanical detachment of bacterial cells from the roots by two sequential steps, involving vortex followed by root homogenization. Bacterial colonization was measured 2 and 24 h after inoculation. These times were selected based on the biphasic model for attachment of A. brasilense and other bacteria to plant roots, by which root colonization comprises a fast, weak and reversible stage that occurs within 2 h, followed by a second step that occurs in the following hours and characterized by firm and irreversible anchoring [Burdman, S. et al., Crit. Rev. Microbiol. 2000, 26, 91-110; Rodriguez-Navarro, D. N. et al., FEMS Microbiol. Lett. 2007, 272, 127-136; Wheatley, R. M. et al., FEMS Microbiol. Rev. 2018, 42, 448-461].

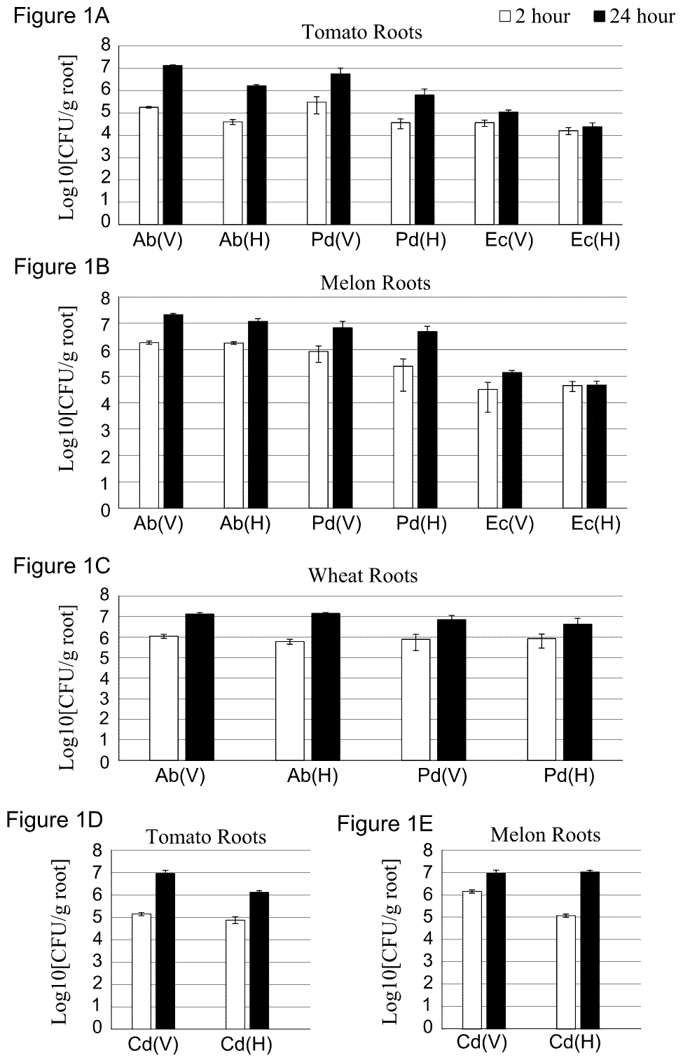

Azospirillum brasilense Sp7, Cd and P. dendritiformis T successfully colonized the roots of the tested varieties of melon, tomato and wheat, with colonization levels varying from ˜10⁵-10⁶ CFU g⁻¹ root after 2 h of incubation to ˜10⁷ CFU g⁻¹ root after 24 h. FIGS. 1A-1E show that colonization abilities of all strains were slightly more efficient in melon and wheat than in tomato roots, particularly at the earliest sampling time. Colonization ability of E. coli cells was poor, reaching levels of only 10⁴ to 10⁵ CFU g⁻¹ in both melon and tomato roots. These results indicate that both A. brasilense (Sp7, Cd) and P. dendritiformis (T) possess the ability to efficiently colonize the roots of melon and tomato roots. Moreover, the levels of root colonization in these plants were comparable to those observed for wheat, a known plant-growth-promotion target of A. brasilense [Michiels, K. W. et al., J. Gen. Microbiol. 1991, 137, 2241-2246]. Further experiments carried out with two other Ananas-type cultivars (Raymond and AN-305), two Galia-type cultivars of melon (Glory and Gaya 2641), as well as with cucumber cv. Beit Alpha and pumpkin cv. Gad, showed similar results as those observed with melon cv. Ofir (not shown).

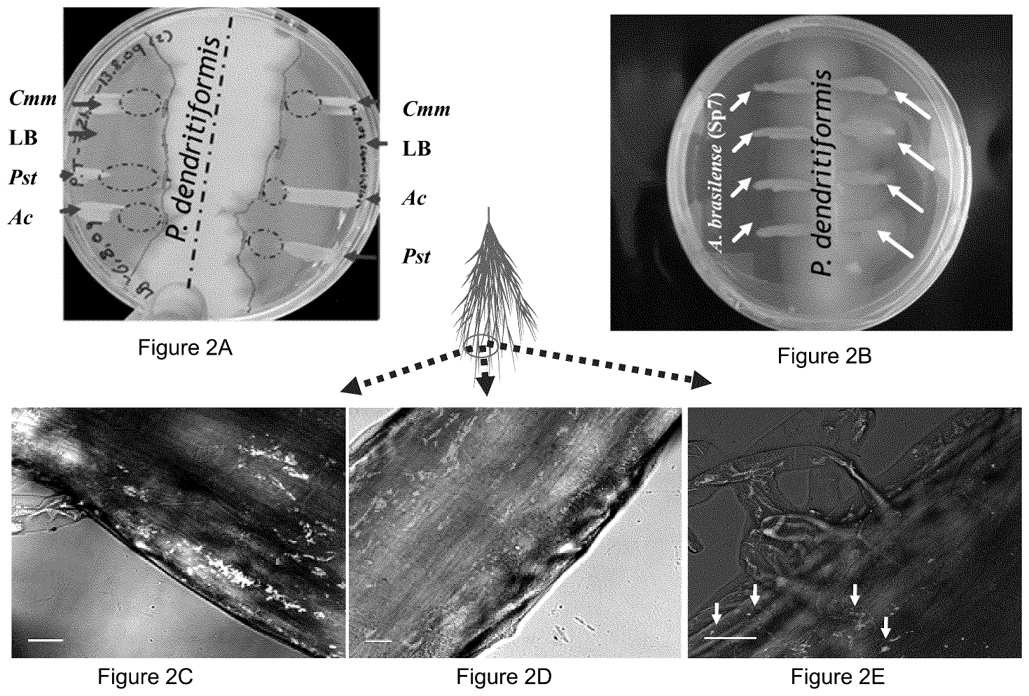

Several studies have shown that P. dendritiformis possesses antimicrobial activities [Radhakrishnan, R. et al., Plant Sci. Today 2021, 8, 941-947; Al-Amoudi, S. et al., Mar. Drugs 2016, 14, 165; Jangra, M. et al., Front. Microbiol. 2018, 9, 2864]. Indeed, when P. dendritiformis T was plated on agar media together with several plant pathogenic bacterial strains, a growth inhibition of the latter was observed (FIG. 2A), whearas no growth inhibition of A. brasilense Sp7 was observed (FIG. 2B). Moreover, preliminary fluorescence in situ hybridization (FISH) analyses using specific probes designed against P. dendritiformis (FIG. 2D) and A. brasilense (FIG. 2C) could detect co-aggregates of the bacterial species on roots of 24 day-old-melon plants grown in sand pots (FIG. 2E). Overall, these results show that these two bacterial strains can be used in co-inoculation application.

These results also emphasize an additional advantage of utilizing P. dendritiformis T, as a potential biological control agent.

Azospirillum brasilense Sp7 and P. dendritiformis T Promote Melon Seedling Growth in Germination Paper Under Salinity Stress

After validating the root colonization abilities of A. brasilense Sp7 and P. dendritiformis T in melon and tomato, plant-growth-promotion assays were carried-out in germination papers soaked in a 50 mM NaCl solution to mimic salinity stress. This salinity concentration, which is relevant to agricultural practices using brackish water for irrigation, was enough to negatively affect the growth parameters of melon plants.

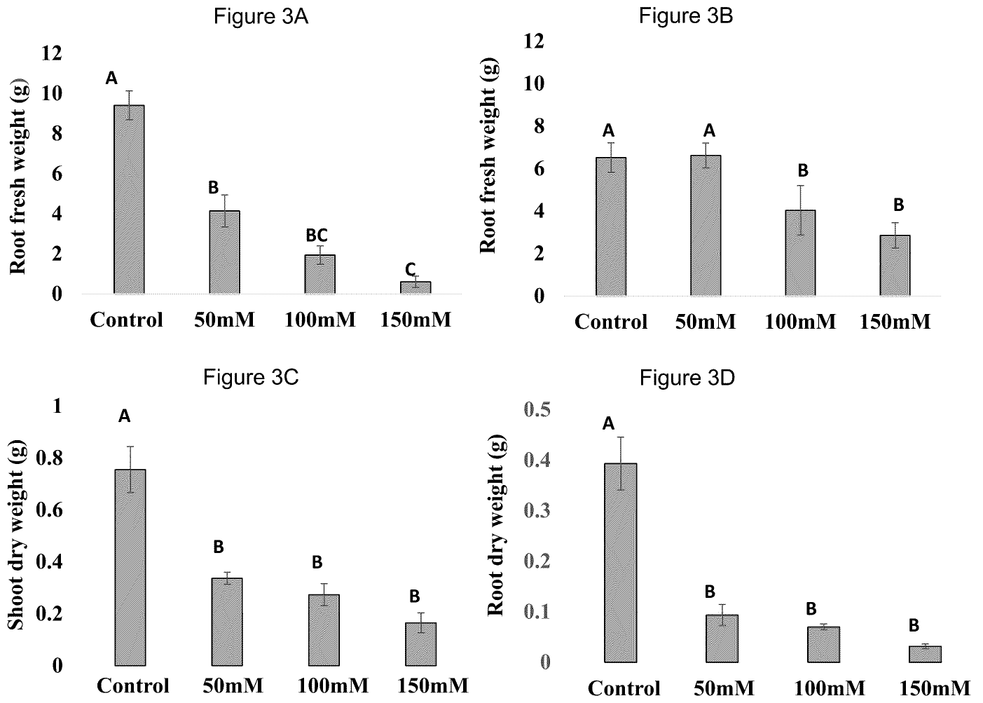

Several experiments showed that the tested varieties of melon (Ofir, Raymond and AN-305) were highly susceptible to 50 mM NaCl. Exposure to saline irrigation at this and higher concentrations of NaCl led to significant (p<0.05) reductions of shoot and root fresh/dry weight of melon plants (shown in FIG. 3A, 3C, 3D for cultivar Ofir). In contrast, no significant differences were observed between tomato plants (variety M82) irrigated with 50 mM NaCl and control plants (without NaCl). In tomato, negative effects of saline irrigation on plant growth parameters started to be observed at a concentration of 100 mM NaCl, which are far higher than real salt concentrations in saline irrigations (FIG. 3B). Therefore, in further experiments done to assess the ability of A. brasilense and P. dendritiformis to attenuate saline stress the inventors focused mainly on melon plants.

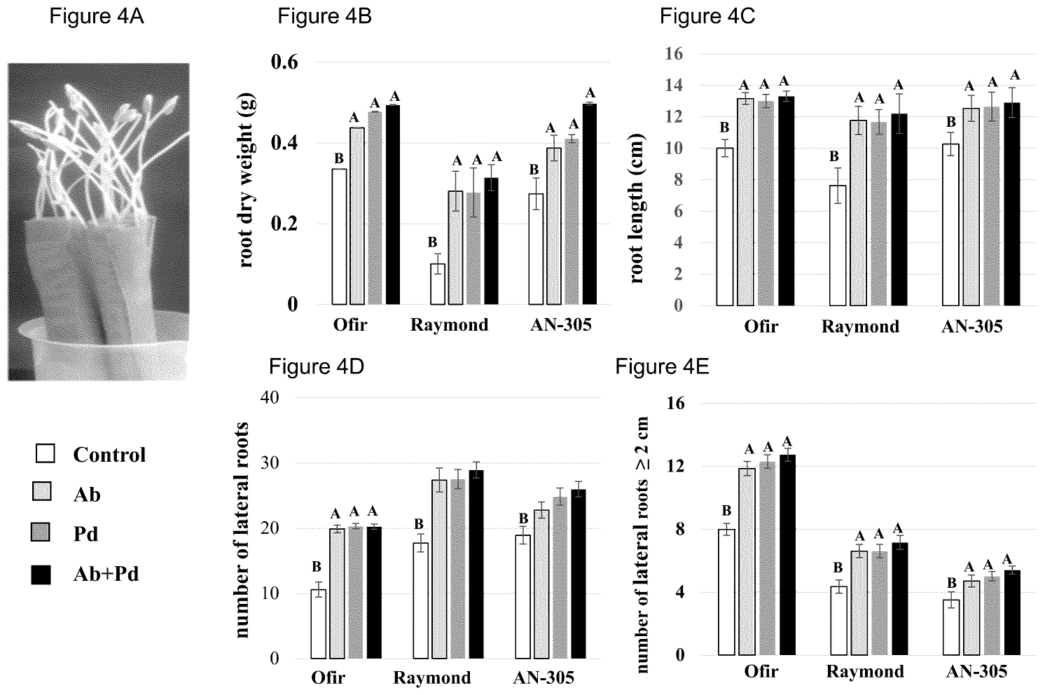

Inoculation with both strains, A. brasilense Sp7 and P. dendritiformis T, separately or together, significantly promoted the growth of melon seedlings of the three tested melon cultivars, Ofir, Raymond and AN-305 (FIGS. 4A-4E). In the three cultivars, significant (p<0.05) increases in root weight, root length, number of lateral roots and number or lateral roots equal or longer than 2 cm were measured for all three bacterial treatments (each strain alone and combined inoculation) as compared to non-inoculated controls (FIGS. 4A-4E). For example, combined-bacterial inoculation treatments increased root weight by 47%, 210% and 81% and root length by 33%, 60 and 25% in Ofir, Raymond and AN-305 cultivars, respectively. While no significant differences were observed between the different inoculation treatments, the combined inoculation of A. brasilense Sp7 and P. dendritiformis T consistently yielded slightly higher root parameter averages than the individual inoculations (FIGS. 4A-4E). Further experiments under the same conditions involving the Galia melon varieties Gaya 2641 and Glory, and cucumber cv. Beit Alpha, yielded similar results (not shown).

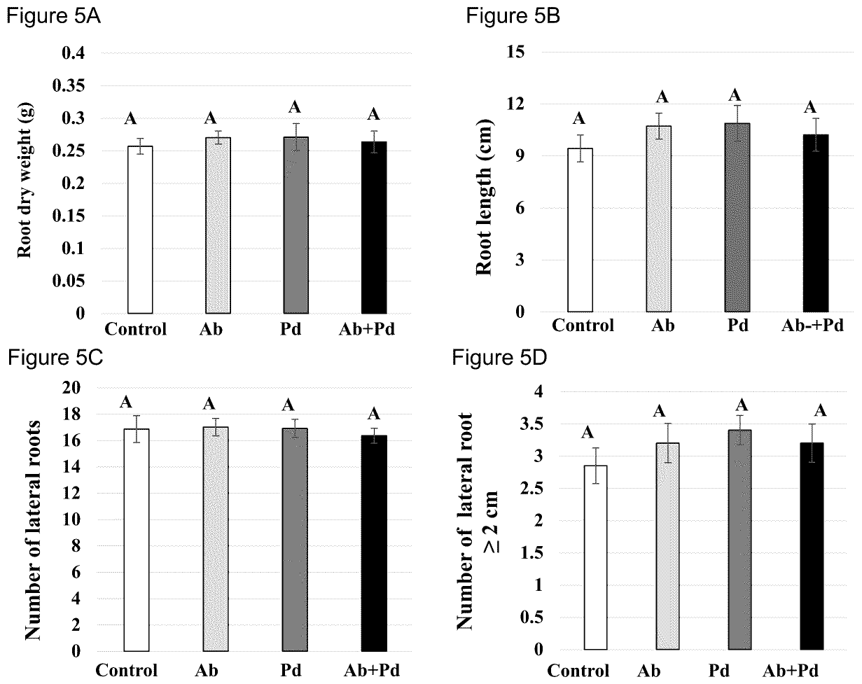

Interestingly, in contrast with the positive effects that bacterial treatment had on melon plants, no significant effects of inoculation were observed in experiments performed with tomato cv. M82 under saline stress of 50 mM NaCl (FIGS. 5A-5D). These results coincide with the fact that tomato plants, in contrast to melon plants, did not exhibit growth inhibition when exposed to 50 mM NaCl (FIG. 4B), suggesting that the plants did not experience significant stress under these conditions.

Azospirillum brasilense Sp7 and P. dendritiformis T Promote Growth of Melon Plants under Salinity Stress in the Greenhouse

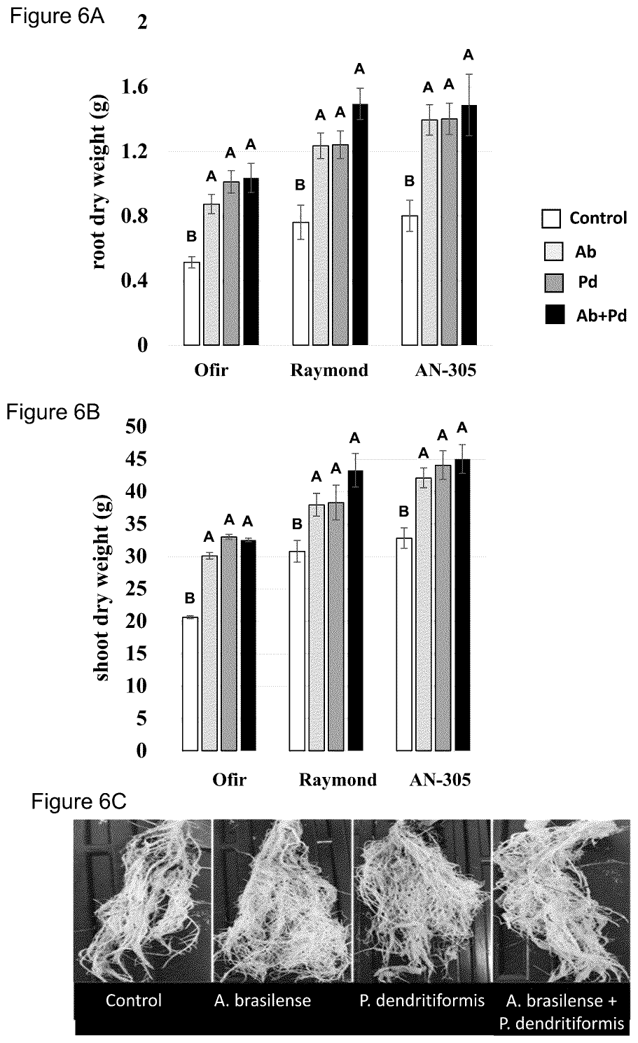

The effects of A. brasilense Sp7 and P. dendritiformis T on plant-growth parameters were also tested on melon and tomato plants grown in the greenhouse under an irrigation regime with saline water. Inoculation with each of the bacterial strains separately or with a combination of both strains, significantly (p<0.05) promoted the growth of the three tested melon cultivars relative to non-inoculated controls (FIG. 6A-6C). In fact, combined bacterial inoculation treatments increased root dry weight by 102%, 96% and 78% and shoot dry weight by 57%, 41% and 37% in Ofir, Raymond and AN-305 cultivars, respectively. Although no significant differences were observed between single and combined inoculation treatment, Raymond and AN-305 plants inoculated with the combination of A. brasilense and P. dendritiformis consistently exhibited a trend of higher shoot and root weight averages compared to plants inoculated with each strain individually (FIGS. 6A-6C). Similar results were observed with the Galia variety Gaya 2641 (not shown).

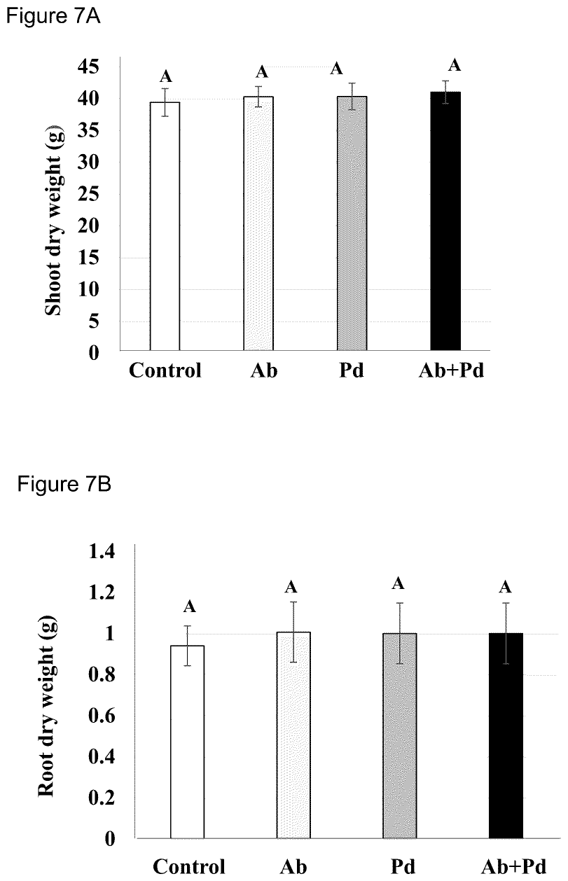

In contrast to the positive effect observed with inoculated melon plants, and as similar as observed in germination paper experiments, bacterial inoculation did not promote the growth of tomato cv. M82 plants in comparison to the untreated control plants (FIG. 7A-7B).

Effects of A. brasilense Sp7 and P. dendritiformis T Inoculation on Total Antioxidant Activity

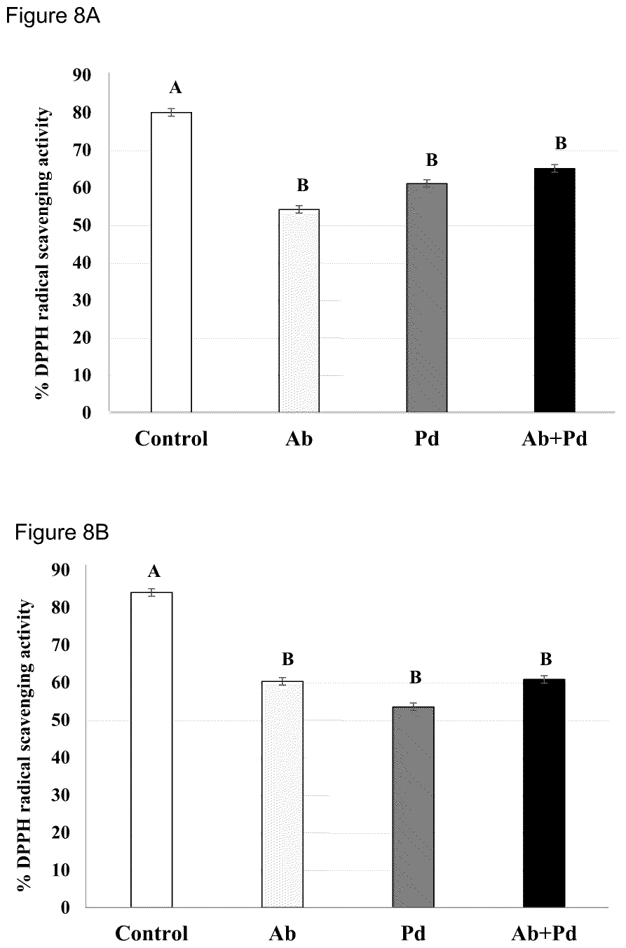

The above results show that inoculation with A. brasilense Sp7 and P. dendritiformis T, separately or together, alleviated the negative effect of saline stress on growth of melon plants. Several studies showed that salinity stress promotes formation of reactive oxygen species and consequent increase of total antioxidant activity in plants [Miranda, D. et al., J. Appl. Bot. Food Qual. 2014, 87, 67-73; Dat, J. et al., Cell. Mol. Life Sci. 2000, 57, 779-795]. Based on this background, the total antioxidant activity in inoculated melon plants was compared relative to controls. The results, presented as the percentage of radical scavenging activity, indicated that indeed, following exposure to salinity stress, roots and leaves of plants inoculated with A. brasilense, P. dendritiformis or a combination of both strains exhibited significantly (p<0.05) lower antioxidant activity as compared with non-inoculated plants (FIGS. 8A-8B). Specifically, scavenging activity measured in roots decreased from 80% in control plants to 54%, 61% and 65% in plants inoculated with A. brasilense Sp7, P. dendritiformis T and their combination, respectively. Similarly, scavenging activity in measured leaves decreased from 84% in control plants to 60%, 53% and 61% in plants inoculated with A. brasilense Sp7, P. dendritiformis T and their combination, respectively.

Combined Inoculation with A. brasilense Sp7 and P. dendritiformis T Increased Melon Yield in the Field under Saline Irrigation

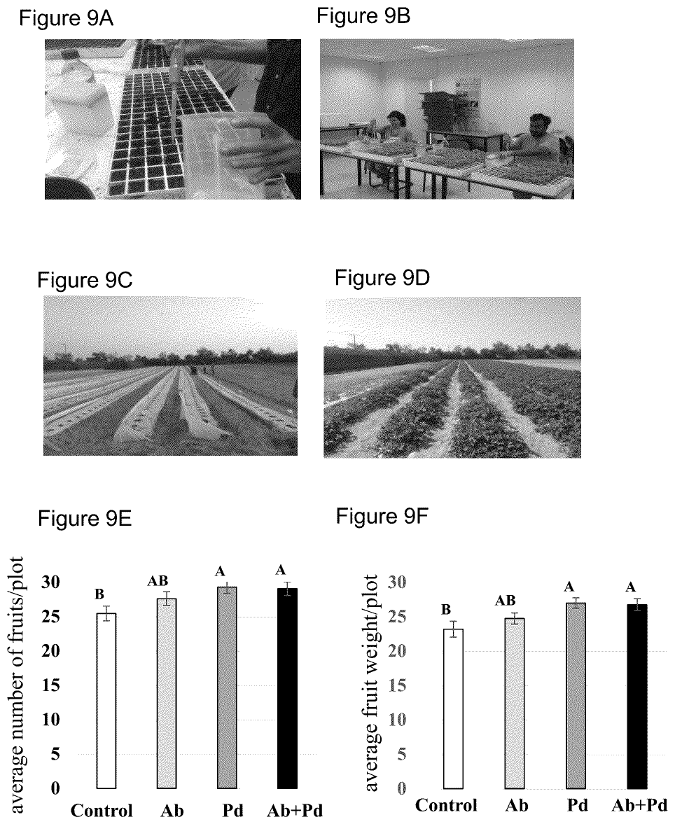

In view of the positive effects of A. brasilense Sp7 and P. dendritiformis T on melon plants in germination paper and greenhouse experiments under saline conditions a field experiment at Ein Tamar (Northern Arava) was set to assess whether inoculation with the two strains can increase fruit yield in the field under irrigation with local, saline water (˜3.5 dS m⁻¹). Importantly, crop cultivation was conducted according to standard commercial practices for melon in the region, including optimized fertilization regime. Even under such optimized conditions (apart the use of saline water for irrigation, i.e., sub-optimal water quality), inoculation with P. dendritiformis T, as well as co-inoculation with A. brasilense Sp7 and P. dendritiformis T resulted in a significantly (p<0.05) higher number of fruits (increases of 16%) and total fruit weight (increases of 15%) per plot as compared to non-inoculated controls (FIGS. 9A-9F). Plants inoculated with A. brasilense Sp7 alone showed increases of 6% and 8% in fruit number and weight, respectively, as compared to non-inoculated controls; however, these differences were not statistically significant. On the other hand, the A. brasilense Sp7 treatment did not significantly differ in these parameters from the P. dendritiformis T and the co-inoculation treatments as well.

In addition to the aforementioned field experiment with melon, a field experiment of tomato was also carried out at the Ramat Negev Agricultural Station with the tomato cultivar Lurka. In this experiment, tomato plants were cultivated in two greenhouses (controlled versus non-controlled temperatures) and under two irrigation regimes (non-saline versus saline irrigation). Co-inoculation of P. dendritiformis T and A. brasilense Sp7 was compared with non-inoculated plants, under the above combinations. In this experiment, the inoculation was done as described above for the melon experiment, at sowing and the transplanting stages. The plantlets were produced by Shorashim (Ein Habsor). In contrast to the positive effects observed in the melon experiment, no significant effect was observed in the case of tomato, on plant growth parameters and yield, by the inoculation treatment.

Biocontrol Activity of Paenibacillus dendritiformis T

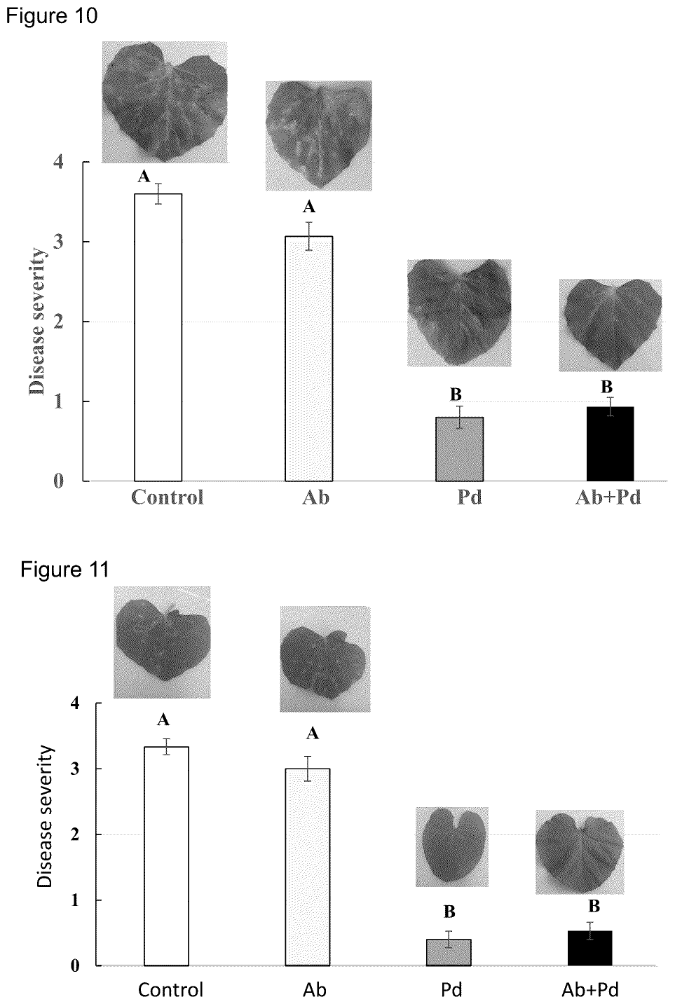

The results presented herein show that P. dendritiformis T is able to inhibit the growth of several plant-pathogenic bacteria including the Gram-positive Clavibacter michiganensis subsp. Michiganensis (causal agent of bacterial canker and wilt disease of tomato), and the Gram-negative Pseudomonas syringae pv. Tomato (causal agent of bacterial speck disease of tomato) and Acidovorax citrulli (causal agent of seedling blight and bacterial fruit blotch of cucurbits) (designated as Cmm, Pst, Ac in FIG. 2A). To further assess the potential of P. dendritiformis T for biological control, the ability to suppress disease in melon leaves caused by A. citrulli was tested. In these experiments, P. dendritiformis T but not A. brasilense Sp7 was able to significantly reduce disease severity in melon leaves inoculated with A. citrulli strain M6. Disease severity was significantly reduced following both spray-inoculation of leaves (FIG. 10) and seed/root treatment (FIG. 11) with P. dendritiformis T. These results indicate that P. dendritiformis is able to provide local protection against the pathogen, but also induces systemic resistance to the foliage following root colonization.

### Example 2

### Biocontrol Experiments

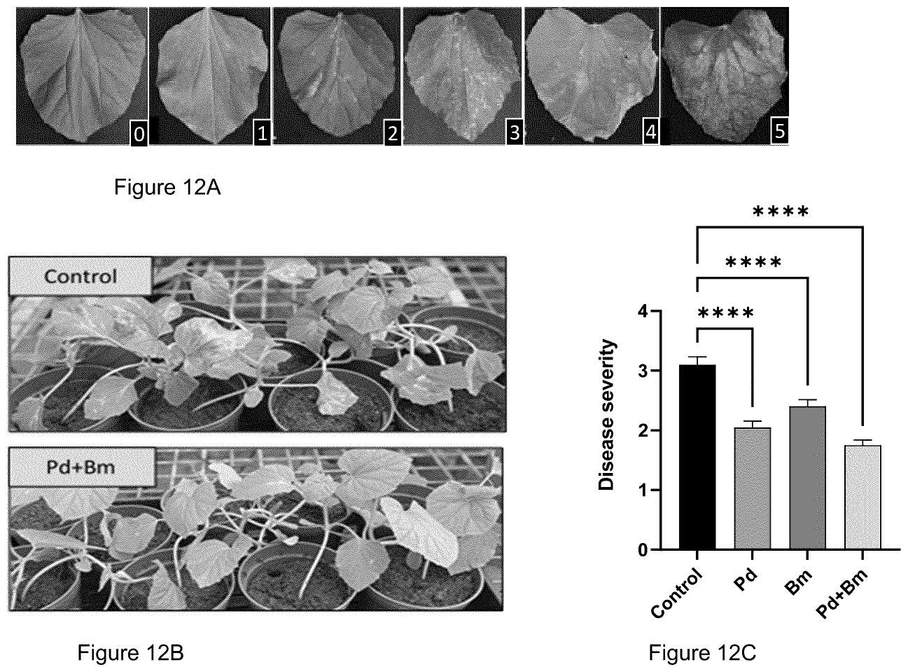

Experiments were carried out to assess the ability of Bacillus mycoides (Bm) and P. dendritiformis T to suppress disease of melon caused by the cucurbit pathogenic bacterium A. citrulli strain M6. The experiment was carried out in a greenhouse at 27-28° C. Melon seeds were sown in trays filled with vermiculite and irrigated with water. After 12 days, the seedlings were transferred to plastic pots (one plant per pot) filled with sand. Two weeks later, the foliage of the plants were spray-inoculated with 10⁶-10⁸ CFU/ml of Bacillus mycoides, P. dendritiformis T, or with a combination of both strains at the same concentrations. Control plants were sprayed with water. After 4 h, the leaves were spray-inoculated with A. citrulli M6 at 10⁶-10⁷ CFU/ml. The plants were then covered with a plastic bag for 24 h to promote infection by A. citrulli. Disease severity was assessed 6 days after inoculation with A. citrulli, using the scale presented in FIG. 12A. Four experiments of each type were carried out with 9-14 replicates (plants) per treatment, per experiment.

In Vitro Analysis of the Interactions Between Bacillus mycoides (Bm) or P. dendritiformis T with A. citrulli Strain

The bacteria strains Bacillus mycoides (Bm) or P. dendritiformis T were grown in liquid Luria Bertani agar (LB) with the pathogenic strain A. citrulli M6 for 24 hours at 28° C. Sequential dilutions of these cultures were plated on LB plates containing kanamycin to calculate the colony forming units (cfu/ml) of A. citrulli M6. Statistical analysis was done using Tukey kramer test (p<0.0001).

Combined Inoculation with Bacillus mycoides (Bm) and P. dendritiformis T Reduces Disease Severity in Melons Induced by A. citrulli in the Greenhouse

Since P. dendritiformis but not A. brasilense Sp7 was able to provide local protection against the pathogen, the effect of another bacterium species from the order bacillales—Bacillus mycoides (Bm) was next examined.

In a greenhouse experiment, the leaves of a melon plant variety of (Rachel, Hazera seeds) were spray inoculated first with A. citrulli followed by spray inoculation with P. dendritiformis T (Pd), Bacillus mycoides (Bm) or with a combination of the strains and the severity of disease was evaluated as compared to non-inoculated controls using a scale for determining necrotic spots in the leaves (FIG. 12A). Inoculation with each of the bacterial strains separately or with a combination of both strains, significantly (p<0.0001) reduce disease severity in melon leaves inoculated with A. citrulli. Relative to non-inoculated controls (FIGS. 12B-12C). Although no significant differences were observed between single and combined inoculation treatment, Rachel plants inoculated with the combination of Bacillus mycoides (Bm) and P. dendritiformis (Pd) exhibited a trend of additive effect of protection from A. citrulli compared to plants inoculated with each strain individually (FIG. 12C).

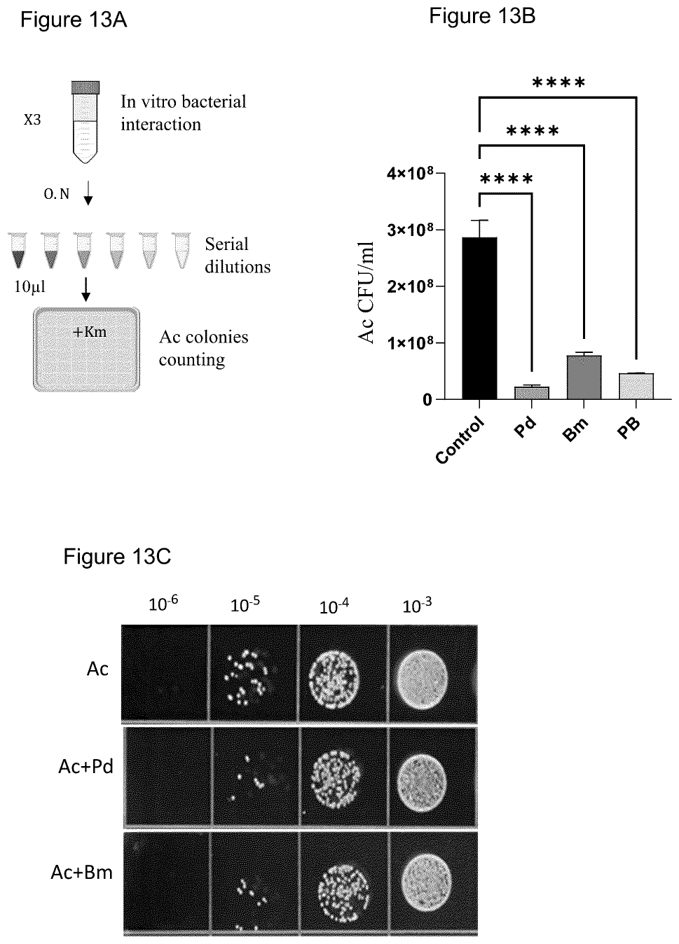

Indeed, in an in vitro assay, it was shown that co-culturing of Bacillus mycoides (Bm) or P. dendritiformis strains with the pathogenic A. citrulli strain resulted in significantly growth inhibition of the latter (FIGS. 13A-13C). These results support the results in the greenhouse experiments that Bacillus mycoides (Bm) and/or P. dendritiformis inhibit the pathogen A. citrulli. The inhibition may require a direct interaction between the bacteria strains or alternatively, the secretion of an inhibitory/toxic factors by Bacillus mycoides (Bm) or P. dendritiformis (Pd) strains.

### Example 3

Effect of P. dendritiformis on Root Development and Plant Biomass Under Nutrient Deficient Conditions

A greenhouse experiment in Hishtil nursery was carried out using NONAME cucumbers plants to assess their susceptibility to nutrient deficiency in the presence/absence of P. dendritiformis strain T. In the experiment, trays of 128 cucumbers NONAME plants were used. Bacterial inoculation was performed twice, the first time at sowing, and the second time at day 7. In both cases, each plant was inoculated with P. dendritiformis strain T bacterial suspension of 5×10⁸ CFU mL⁻¹. Negative control was of non-inoculated plants which were fertilized only in the substrate (no additional fertilization during irrigation); and positive control was plants which were non-inoculated but continuously fertilized during irrigation. Two heat waves occurred during the experiment, the first 3 days following sowing, and the second at day 10. Two groups of plants were inoculated with P. dendritiformis strain T, in which one of them was supplemented with growth enhancers (GE) in an amount of the GE which does not affect the plant growth per se, i.e. when given alone, but improved bacterial survival while brought into contact with the plant or plant part together with the bacterial composition.

TABLE 2
Treatment protocol

| Day | Treatment | Description |
|---|---|---|
| 0 | Seeding and first | Spraying of P. dendritiformis T bacterial |
| | inoculation | suspension of 5 × 10⁸ CFU mL⁻¹ |
| 7 | Second inoculation | Spraying of P. dendritiformis T bacterial |
| | | suspension of 5 × 10⁸ CFU mL⁻¹ |
| 14 | Observation | Observation only |
| 20 | End of treatment and | Observation |
| | measurements | Measuring leaves mass |
| | | Measuring root development |

At day 14 and 20 the leafs biomass and root quality of the plants in the various groups was determined. The root's quality of the cucumbers was determined using a grading that consists of classifying the roots into 3 categories based on their quality and corresponding profit value in the market: complete value (full price); acceptable value (sold by the grower but in reduced price); undeveloped (the crop is discarded).

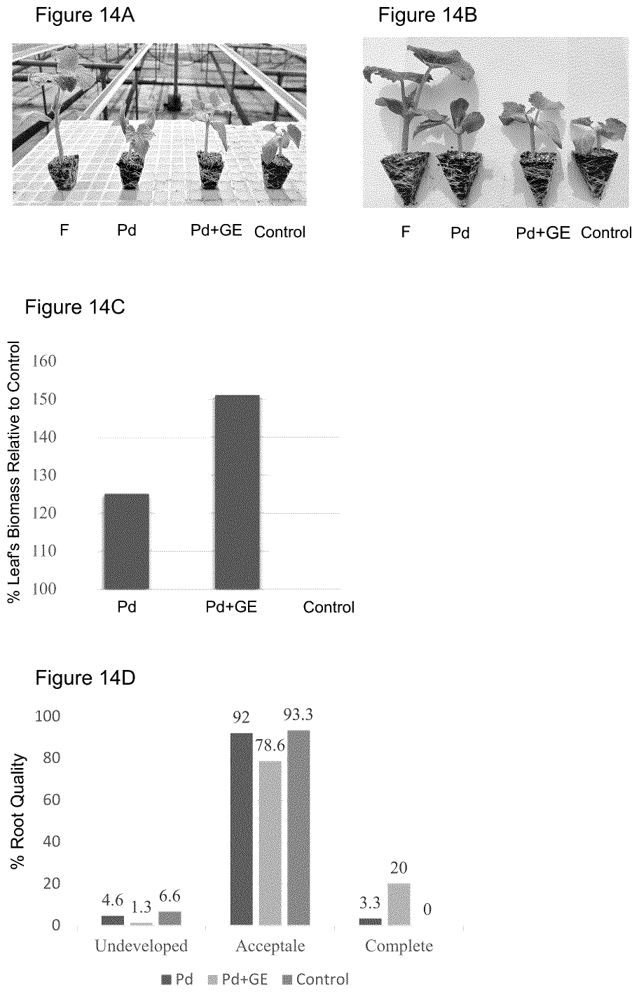

In a greenhouse experiment, it was shown that the inoculation of P. dendritiformis on the cucumber plants improved the leafs biomass relative to the untreated plants. The increase in the leafs biomass was more pronounced when the plants were treated also with GE (FIGS. 14A-14C). Significant improvement in root quality was also observed in plants inoculated with P. dendritiformis and supplemented with GE (FIG. 14D). The percentage of plants with good quality of roots which is considered as “complete” by those versed in the art of growing cucumbers, was increased in plants inoculated with P. dendritiformis and supplemented with GE to 20% relative to the corresponding control plants. Similarly, the percentage of plants with a bad roots quality which is considered by those versed in the art as “undeveloped”, and thus discarded by the growers, was decreased from 6.6% in control plants to about 1.3% in plants inoculated with P. dendritiformis and supplemented with GE (FIG. 14D).

1-38. (canceled)

39. A method for improving at least one plant-related parameter in cucurbitaceous plant, said plant-related parameter characterizes the health and/or productivity of said plant or of a part thereof, the method comprising: contacting a plant or plant part with an amount of at least one bacterium, the at least one bacterium comprising at least Paenibacillus dendritiformis (P. dendritiformis), the amount of said at least one bacterium being effective to provide an improvement in said at least one plant-related parameter.

40. The method of claim 39, wherein said P. dendritiformis is from strain T168 or from C454.

41. The method of claim 39, wherein said at least one bacterium comprises at least one additional bacterium selected from the group consisting of Bacillus mycoides and Azospirillum brasilense (A. brasilense).

42. The method of claim 41, wherein said A. brasilense is from strains Sp7 or Cd.

43. The method of claim 39, wherein said plant part comprises at least one of plant root, plant leaves, plant seeds, plant stem, plant harvestable material, plant shoots, flowers, stalks, fruit bodies, harvested material, tubers, rhizomes, plant seedlings and combination of same.

44. The method of claim 39, wherein said cucurbitaceous plant is selected from the group consisting of: melon (Cucumis melo), cucumber (Cucumis sativus), and pumpkin (Cucurbita pepo).

45. The method of claim 39, wherein said at least one plant-related parameter is selected from the group consisting of germination rate, germination percentage, robustness of germination, growth rate, root biomass, root structure, root development, shoot length, shoot mass, leaf area, number of leaves per plant, leaf weight, fruit size, fruit morphology, fruit biomass, number of fruit per plant, seed count, seed size, seed morphology, plant vigor, plant total biomass, plant or plant part morphology and/or size, plant pigment, plant viability, smell, physiological state, phonological stage of plant growth, nutrient status or deprivation, chlorophyll content, photosynthetic capacity, time to crop maturity, crop yield and/or quality, colorization or veins structure, water content or status, disease condition, resistance or tolerance to pests or pathogens, tolerance or resistance to abiotic stress conditions, tolerance or resistance to biotic stress conditions and any combination thereof.

46. The method of claim 45, wherein said at least one plant-related parameter is at least tolerance or resistance to abiotic stress conditions comprising plant growth under salinity stress.

47. The method of claim 45, wherein said at least one plant-related parameter is at least tolerance or resistance to abiotic stress conditions comprising plant growth under nutrient and/or mineral deficiency.

48. The method of claim 45, wherein said biotic stress conditions comprise cucurbit pathogenic bacterium Acidovorax citrulli. (A. citrulli).

49. The method of claim 39, wherein said contacting comprises at least one procedure selected from the group consisting of contacting seedling roots with said at least one bacterium, irrigating said plant or plant part with said at least one bacterium, spraying said plant or plant part with said at least one bacterium, irrigating soil in vicinity of said plant or plant part with said at least one bacterium, contacting plant seeds with said at least one bacterium, and any combination thereof.

50. The method of claim 41 wherein the ratio between said P. dendritiformis and said at least one additional bacterium is between about 1:10 and about 10:1.

51. The method of claim 50, wherein said ratio is about 1:1.

52. A composition for use in improving at least one plant-related parameter in cucurbitaceous plant, said plant-related parameter characterizes the health and/or productivity of said plant or of a part thereof, the composition comprising at least one bacterium and an agriculturally acceptable carrier, the amount of said at least one bacterium being effective to provide an improvement in said at least one plant-related parameter, wherein the at least one bacterium comprising at least Paenibacillus dendritiformis (P. dendritiformis).

53. The composition for use of claim 52, wherein said at least one plant-related parameter is at least tolerance or resistance to abiotic stress conditions comprising plant growth under salinity stress.

54. The composition for use of claim 52, wherein said P. dendritiformis is from strain T168 or from C454.

55. The composition for use of claim 52, comprising at least one additional bacterium wherein said at least one additional bacterium selected from the group consisting of Bacillus mycoides and Azospirillum brasilense (A. brasilense).

56. The composition for use of claim 55, wherein said A. brasilense is from strains Sp7 or Cd.

57. The composition for use of claim 52, wherein said cucurbitaceous plant is selected from the group consisting of: melon (Cucumis melo), cucumber (Cucumis sativus), and pumpkin (Cucurbita pepo).

58. A kit comprising
at least one bacterium that is capable for improving at least one plant-related parameter in cucurbitaceous plant, said plant-related parameter characterizes the health and/or productivity of said plant or of a part thereof, wherein the at least one bacterium comprises at least Paenibacillus dendritiformis (P. dendritiformis);
instructions for use of the at least one bacterium, said instructions comprises contacting a plant or plant part from cucurbitaceous family, with an amount of said at least one bacterium, the amount of said at least one bacterium being effective to provide an improvement in said at least one plant-related parameter.
